(19) United States
(12) Patent Application Publication
(10) Pub. No.: US 2007/0146778 A1
(43) Pub. Date: Jun. 28, 2007

(54) PRINT SYSTEM, SERVER SYSTEM, AND JOB CONTROL METHOD

(76) Inventors: Kei Kitagata, Kanagawa-ken (JP); Shin Muto, Kanagawa-ken (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/610,575

(22) Filed: Dec. 14, 2006

(30) Foreign Application Priority Data
Dec. 28, 2005 (JP) 2005-380163
Nov. 10, 2006 (JP) 2006-305977

(51) Int. Cl. G06F 3/12

(52) U.S. Cl. 358/1.15; 358/1.16

(57) ABSTRACT

In a print system communicable with an information processing apparatus and print apparatus, the information processing apparatus holds one or a plurality of print jobs in a readable form based on identification information common to a plurality of print jobs transmitted from the print apparatus. When the print apparatus issues a request accompanying identification information to the information processing apparatus, the information processing apparatus receives the issued request, and reads one or a plurality of print jobs on the basis of the identification information contained in the received request. Then, the information processing apparatus outputs the read print job to the print apparatus.

### BACKGROUND OF THE INVENTION

1. Field of the Invention

The present invention relates to a print system, server system, and job control method and, more particularly, to a mechanism of outputting a print job in accordance with a request from a print apparatus.

2. Description of the Related Art

There is proposed a system in which a print apparatus designates target print data, receives the target print data based on the designation or a print job based on the target print data via a communication line, and prints out on the basis of the received data. This system is known as a pull-print system. For example, Japanese Patent Laid-Open No. 08-263414 discloses this technique.

In the pull-print system, however, a user must use the operation unit of a print apparatus to designate the job name of a print job to be received from a print server. This system obligates the user to do cumbersome work. There is also known a technique which prompts a user to designate not the name of a print job but the location (so-called URL) of target print data through the operation unit of a print apparatus and pull-print. This technique also has the same problem of forcing the user to do cumbersome work.

### SUMMARY OF THE INVENTION

The present invention has been made to overcome the conventional drawbacks, and has as its object to easily designate target print data in a pull-print system.

It is another object of the present invention to easily control a print job.

According to one aspect of the present invention, there is provided a server system communicable with a print apparatus, comprising: a job generation unit adapted to generate a print job in accordance with a print instruction; a holding unit adapted to hold at least one print job generated by the job generation unit in a readable form based on identification information common to a plurality of print jobs transmitted from the print apparatus; a first reception unit adapted to receive a request accompanying identification information from the print apparatus; and an output unit adapted to read at least one print job on the basis of the identification information contained in the request received by the first reception unit, and output the read print job to the print apparatus.

According to another aspect of the present invention, there is provided a print system in which an information processing apparatus and a print apparatus are communicable with each other, wherein the information processing apparatus comprises: a job generation unit adapted to generate a print job; and a holding unit adapted to hold at least one print job in a readable form based on identification information common to a plurality of print jobs transmitted from the print apparatus, the print apparatus comprises an issue unit adapted to issue a request accompanying identification information to the information processing apparatus, and the information processing apparatus further comprises: a first reception unit adapted to receive the request issued by the issue unit; and an output unit adapted to read at least one print job on the basis of the identification information contained in the request received by the first reception unit, and output the read print job to the print apparatus.

Furthermore, according to another aspect of the present invention, there is provided a job control method by a server system communicable with a print apparatus, comprising: a job generation step of generating a print job in accordance with a print instruction; a holding step of holding, in a holding unit, at least one print job generated in the job generation step in a readable form based on identification information common to a plurality of print jobs transmitted from the print apparatus; a first reception step of receiving a request accompanying identification information from the print apparatus; and an output step of reading at least one print job on the basis of the identification information contained in the request received in the first reception step, and outputting the read print job to the print apparatus.

Furthermore, according to another aspect of the present invention, there is provided a job control method by a print system in which an information processing apparatus and a print apparatus are communicable with each other, comprising: a job generation step of causing the information processing apparatus to generate a print job; a holding step of causing the information processing apparatus to hold, in a holding unit, at least one print job in a readable form based on identification information common to a plurality of print jobs transmitted from the print apparatus; an issue step of causing the print apparatus to issue a request accompanying identification information to the information processing apparatus; a first reception step of causing the information processing apparatus to receive the request issued in the issue step; and an output step of reading at least one print job on the basis of the identification information contained in the request received in the first reception step, and outputting the read print job from the information processing apparatus to the print apparatus.

Further features of the present invention will become apparent from the following description of exemplary embodiments with reference to the attached drawings.

### BRIEF DESCRIPTION OF THE DRAWINGS

FIG. 1 is a block diagram showing an example of the overall configuration of a print system according to an embodiment;

FIG. 2 is a block diagram for explaining an example of the hardware configuration of a network printer (also called a print device) according to the embodiment;

FIG. 3 is a block diagram showing an example of the configurations of a pull-print server and its peripheral software in a client PC;

FIG. 4 is a block diagram showing an example of the sequence of a print job in printing in the pull-print server and its peripheral software;

FIG. 5 is a block diagram showing an example of the software configuration of the network printer;

FIG. 6 is a block diagram showing an example of the software configuration of the user application of the network printer;

FIG. 7 is a chart showing an example of a print sequence between the pull-print server, a device scheduler, an LPD/RAW, and a printer controller;

FIG. 8 is a view for explaining the schematic operation of the embodiment;

FIGS. 9A and 9B are flowcharts showing an example of a process to register a job in the pull-print server;

FIG. 10 is a view showing an example of print job information and a job management queue managed by the pull-print server;

FIG. 11 is a view showing an example of printer information and output port information managed by the pull-print server;

FIG. 12 is a flowchart showing an example of a process to acquire user identification information by a pull-print agent and notify the pull-print server of the information;

FIG. 13 is a view showing an example of information transmitted from the pull-print agent to the pull-print server;

FIG. 14 is a flowchart showing an example of a sequence until the pull-print server transfers print data after specifying the data;

FIG. 15 is a view showing an example of client information and a client management queue managed by the device scheduler;

FIG. 16 is a view showing an example of job information and a job management queue managed by the device scheduler;

FIG. 17 is a flowchart showing an example of a process by a communication connection management unit which processes a request and notification from the pull-print server, a notification from a device management unit, and a request and notification to a job management unit;

FIG. 18 is a flowchart showing an example of the sequence of a process by the schedule management unit of the device scheduler until the schedule management unit issues schedule up after accepting a scheduling request from the pull-print server;

FIG. 19 is a flowchart showing an example of a process from acceptance of a job status notification event from the device management unit to acceptance of a job list request;

FIG. 20 is a flowchart showing an example of a process by the device management unit when accepting a device status or job status notification from the printer controller;

FIG. 21 is a flowchart showing an example of the sequence of a process by the pull-print server when accepting a notification or command from the device scheduler;

FIG. 22 is a flowchart for explaining an example of a process by the pull-print server when receiving a job cancellation & holding instruction;

FIG. 23 is a chart showing an example of a print sequence between a pull-print server, a device scheduler, an LPD/RAW, and a printer controller according to the second embodiment;

FIG. 24 is a flowchart showing an example of a process by the device scheduler until it completes a print process through schedule up after receiving a scheduling request from the pull-print server;

FIGS. 25A and 25B are flowcharts for explaining examples of a job control process by the pull-print server;

FIG. 26 is a view showing an example of job information managed by the pull-print server using a job management queue; and

FIG. 27 is a block diagram showing an example of a print job holding mechanism.

### DESCRIPTION OF THE EMBODIMENTS

Preferred embodiments of the present invention will now be described in detail in accordance with the accompanying drawings.

### First Embodiment

<System Configuration>

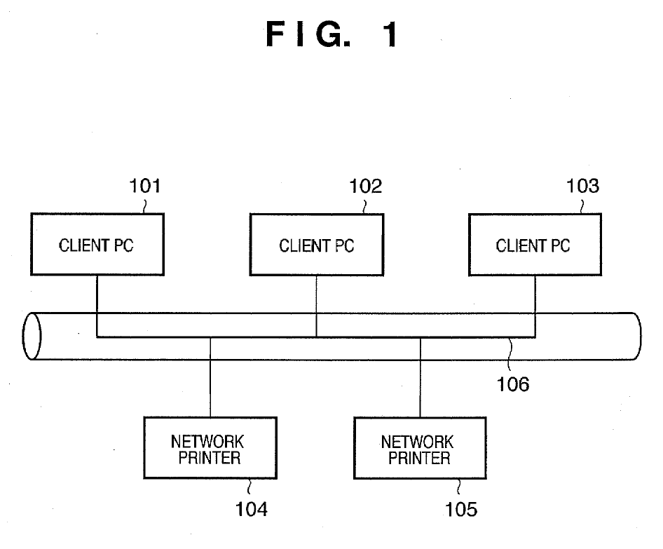

FIG. 1 is a block diagram showing the overall configuration of a print system according to the first embodiment. The print system comprises client PCs (computers) 101 to 103 serving as information processing apparatuses, and network printers 104 and 105 serving as printing apparatuses (print devices). These apparatuses are connected to each other through network cable 106 to form a network as a whole.

The client PCs 101 to 103 store an executable print control program. The client PCs 101 to 103 have a function of managing the network printers 104 and 105 included in the print system, and a function of accumulating files used on the network and monitoring the busy condition of the network. More specifically, the client PCs 101 to 103 have a function of creating a print job by themselves and issuing a scheduling request to the schedulers of the network printers 104 and 105. The client PCs 101 to 103 have a function of starting the transfer of print data in accordance with instructions from the schedulers of the network printers 104 and 105.

The network printers 104 and 105 are physical print devices which receive print data-containing print jobs from the client PCs 101 to 103, and analyze and print the received print jobs. As the network printers 104 and 105, all types of print apparatuses are available including a laser beam printer using an electrophotographic method, an inkjet printer using an inkjet method, and a printer using a thermal transfer method.

The network printers 104 and 105 have

functions of accepting print requests from the client PCs 101 to 103, determining the order of accepted print requests, and issuing a print instruction, and

functions of monitoring print jobs transferred to the network printers 104 and 105 and the statuses of the network printers 104 and 105, and notifying the client PCs 101 to 103 of the end of printing and the printer statuses.

Communication between apparatuses included in the print system may be wired communication using an Ethernet® cable or the like, or wireless communication using radio waves, light, or the like.

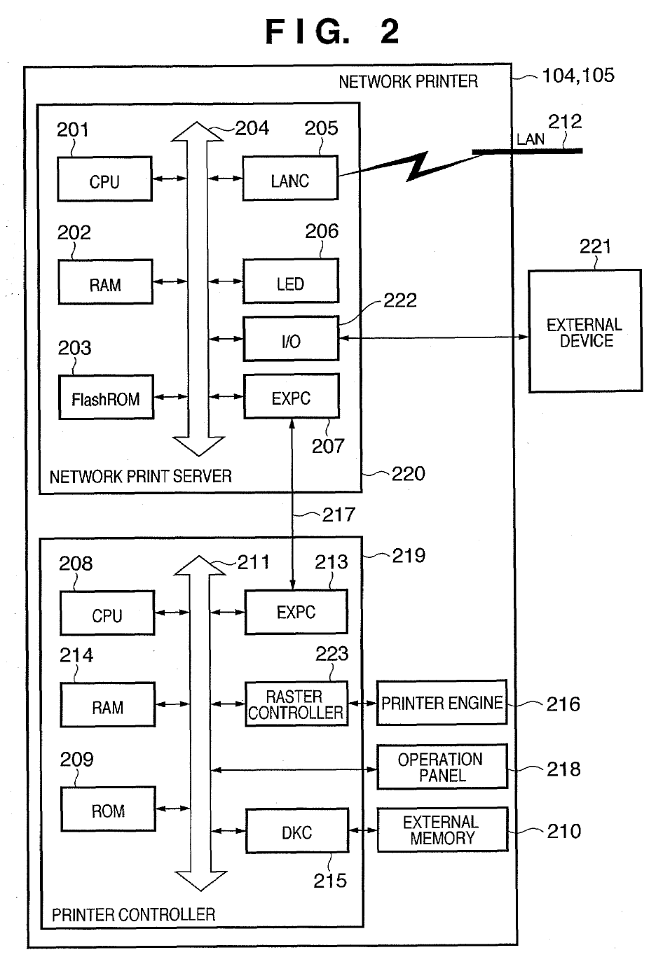

FIG. 2 is a block diagram for explaining the hardware configuration of the print system according to the first embodiment. The network printers 104 and 105 (to be referred to as a network printer hereinafter) roughly comprise two devices, i.e., a network print server 220 and printer controller 219 which manage different control systems. In the network print server 220, a network print server CPU 201 (to be referred to as a CPU 201 hereinafter) implements various control operations on the basis of control programs stored in a rewritable flash ROM 203. For example, the CPU 201 uses a network controller (LANC) 205 connected to a system bus 204 to control communication with a plurality of external devices (not shown) such as a host computer connected to a local area network (LAN) 212. In this communication, the CPU 201 uses a predetermined network communication protocol to comprehensively control print data and various data transmission/reception requests (e.g., a printer control instruction) sent from an external device. The CPU 201 performs proper data transfer control to the printer controller 219 connected via an expansion interface controller (EXPC) 207.

A RAM 202 serves as a temporary storage area such as a main memory and work area for the CPU 201. An LED 206 is an indicator which indicates various operation statuses of the network print server 220 by LED flashing patterns and colors. Displayed operation statuses are, for example, an electrical connection (LINK) between the network controller (LANC) 205 and the local area network (LAN) 212, and a network communication mode (e.g., 10Base, 100Base, full-duplex, or half-duplex).

An expansion interface 217 connecting the network print server 220 and printer controller 219 comprises a connector (not shown). The network print server 220 is detachable, is formed from, e.g., a printed board, and is also mountable on another printer having the same arrangement.

In the printer controller 219, a printer controller CPU 208 comprehensively controls access to various devices connected to a system bus 211. The CPU 208 implements this control on the basis of a control program or the like stored in a ROM 209, or a control program, resource data (resource information), or the like stored in an external memory 210 connected via a disk controller (DKC) 215. For example, the CPU 208 causes a raster controller 223 to generate output image information on the basis of print data received from the network print server 220 connected via an expansion interface controller (EXPC) 213. The CPU 208 causes a printer engine 216 to output the generated image signal. The printer engine 216 adopts a known printing technique. Preferable examples of the printing technique are electrophotographic printing (laser beam printing), inkjet printing, sublimation printing, and thermal transfer printing.

A RAM 214 functions as a main memory, work area, and the like for the CPU 208, and the memory capacity is expandable by an optional RAM connected to an expansion port (not shown). An operation panel (operation unit) 218 has a button for allowing a user to set the operation mode of the network printer 104 and the like, and perform an operation such as cancellation of print data. The operation panel 218 also has an indicator (e.g., an LED) and a liquid crystal panel presenting the operation status of the network printer 104. An external I/O interface 222 exchanges information with an external device 221.

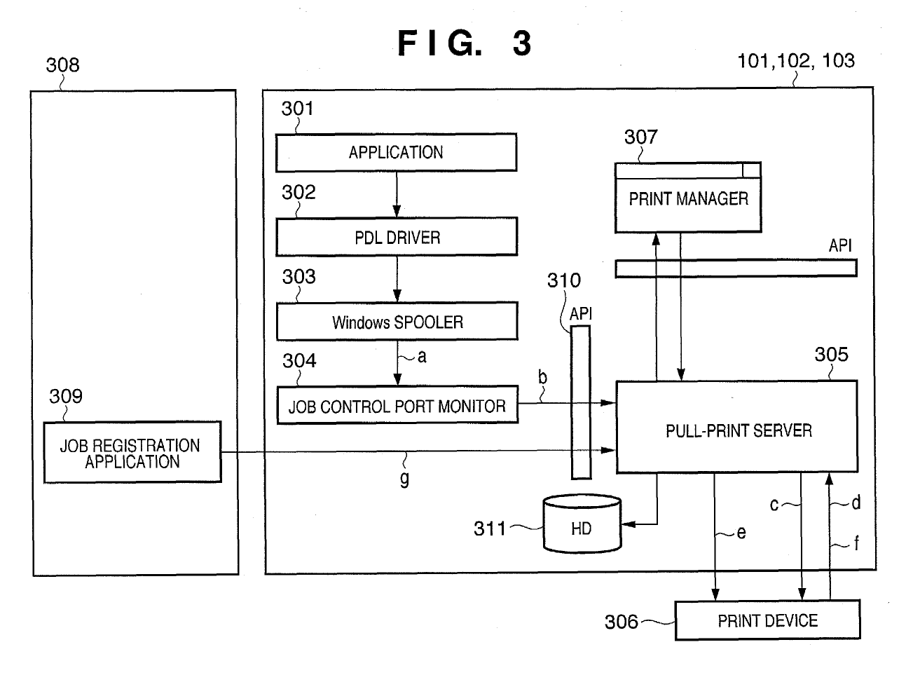

The software configuration of a pull-print server 305 (FIG. 3) present in each of the client PCs 101 to 103 of the print system will be explained. The pull-print server is sometimes called a server system in the sense that it is made up of a plurality of software functions. The following description uses the term “pull-print server”. FIG. 3 is a block diagram showing an example of the software configuration in the pull-print server 305. Arrows between building components represent how to process a drawing command-containing print job issued from an application. The software configuration represented by blocks is provided by executing a predetermined control program by a CPU (not shown) in the client PC. In FIG. 3, a print device 306 represents the network printers 104 and 105.

Generally upon accepting a print instruction, a general application program 301 such as Microsoft Word® generates a series of drawing commands via an OS. A PDL (Page Description Language) driver 302, which has received these drawing commands from the host application via the OS, generates a print job containing a PDL file interpretable by the network printers 104 and 105 on the basis of the series of drawing commands.

To transmit the print job to the print device 306, the PDL driver 302 delivers the generated print job to a spooler 303. This embodiment assumes a Windows® OS, so the spooler 303 is a Windows® spooler. However, the OS of a computer to which the present invention is applied is not limited to Windows®, and the present invention is applicable to another OS as far as the OS supports a drawing command.

The spooler 303 takes a procedure (arrow a) to deliver the print job to a port monitor (304) which is selected and designated by a user via a user interface, and transmit the print job to the print device 306 such as the network printer 104 or 105. The following description assumes that the user designates in advance a port monitor 304 (to be abbreviated as a job control port monitor hereinafter) for transferring print data to the pull-print server 305, and designates printing.

The job control port monitor 304 also receives print setting information (e.g., paper size and stapling instruction) set via a printer driver interface. The job control port monitor 304 transmits the print job and print setting information to the pull-print server 305 which provides a print service (arrow b). In the client PCs 101 to 103, a job registration application 309 of a pull-print server 308 different from the pull-print server 305 inputs print data to the pull-print server 305 via an API 310 (arrow g). In this manner, the first embodiment is applicable to a case where host applications exist at various locations.

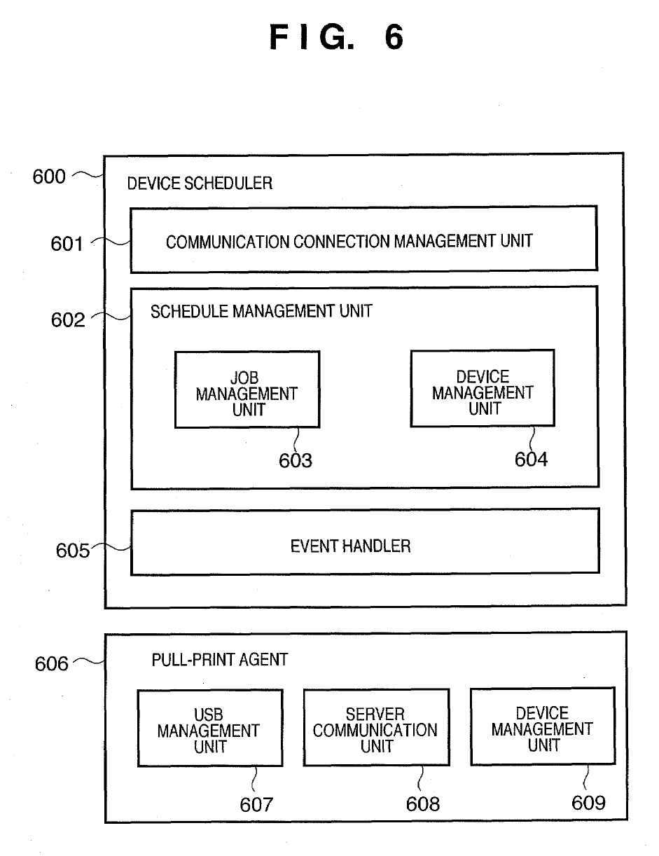

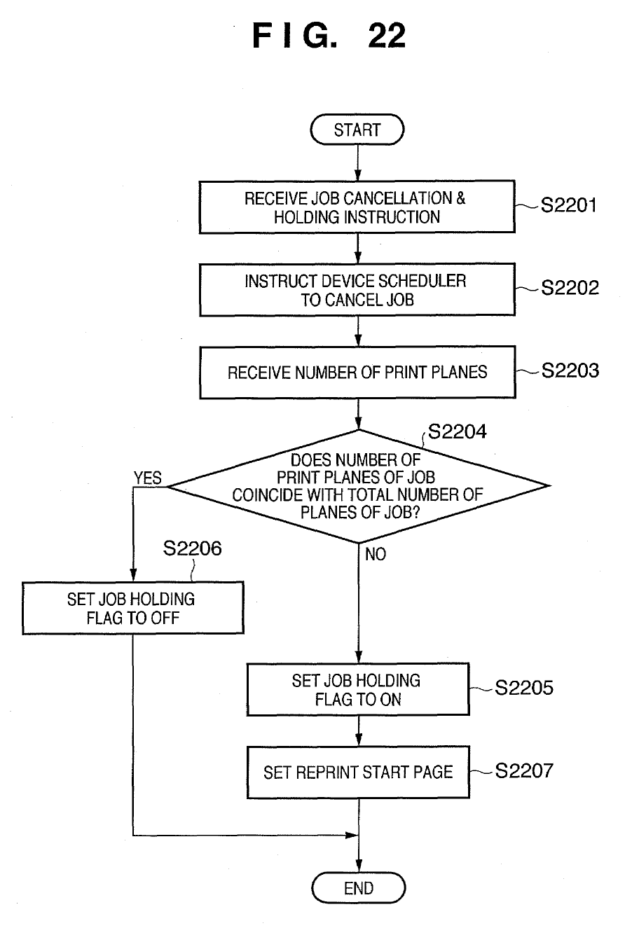

The pull-print server 305 has a function of managing a transferred print job and device status. The pull-print server 305 also has a function of managing information (e.g., a device status or job status) sent from the print device 306, and issuing a predetermined instruction to the print device 306. This function corresponds to a function of managing device information and job information of a plurality of print devices (in this example, the network printers 104 and 105). Before transmitting print data to the print device 306, the pull-print server 305 issues a print request to the print job order management function of the print device 306. When the turn to execute printing has come on the basis of the order management function, the pull-print server 305 transmits print data to the print device 306 in accordance with a print instruction from the print device 306 (arrows c, d, and e). If a pull-print agent 606 (FIG. 6) cannot detect the presence of an authentication information recording medium 521 during printing, the pull-print server 305 instructs the print device 306 to cancel (stop/interrupt) printing (S2203). The operation of the pull-print server 305 will be described in detail with reference to FIGS. 6 and 22.

The print device 306 notifies the pull-print server 305 of the status of the print device 306 (arrow f). For example, after confirming the completion of print data, the print device 306 notifies the pull-print server 305 of the completion of printing.

A print manager 307 is a program providing a user interface which allows a user to check the status of a print job in the pull-print server 305, and display and operate a print job. The print manager 307 exchanges information and instructions with the pull-print server 305 via the software interface (API: Application Program Interface) of the pull-print server 305. The print manager 307 presents a display based on the exchanged information. The print manager 307 has a function of mainly acquiring, as an event, status information of the print device 306 managed by the pull-print server 305. Event notification types are an error/warning information notification (e.g., a warning about shortage of the remaining toner amount, a communication failure between the pull-print server and a device, an insufficient memory capacity, or overloading on the delivery tray), and a normal information notification representing recovery from an error state to a normal state. Another event notification type is a job progress (e.g., the number of printed/discharged planes or a print job end status). The pull-print server 305 has a function of accepting the notification of a status (e.g., ongoing printing, power control status, or failure information (paper jam)) of each device (print apparatus) communicable via a network.

As a more detailed process, the print manager 307 issues a device-designated event to the pull-print server 305. The pull-print server 305 recognizes the status of the device designated by the issued event, and notifies the print manager 307 of the result based on monitoring.

<Sequence of Print Job>

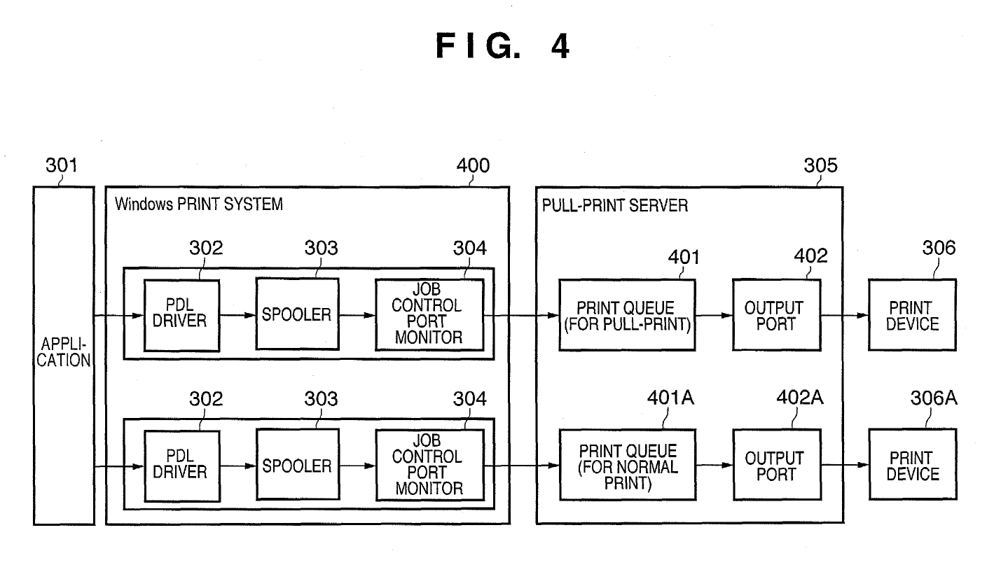

The sequence of a print job from the application 301 to the print device 306 will be described with reference to FIG. 4. The same reference numerals as those in FIG. 3 denote the same software elements.

As shown in FIG. 4, the PDL driver 302, spooler 303, and job control port monitor 304 are conceptually prepared for each print device 306 or 306A. When the OS is Windows®, these elements are sometimes called a Windows® print system 400 at once. The print devices 306 and 306A correspond to the network printers 104 and 105.

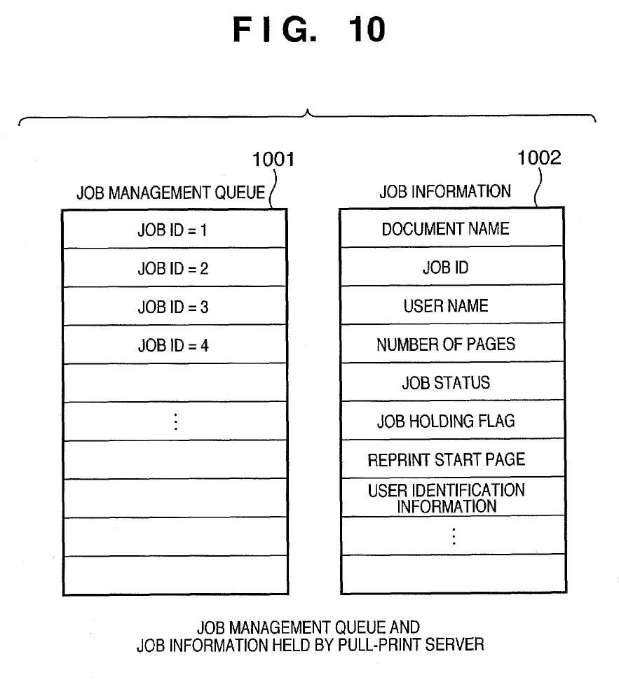

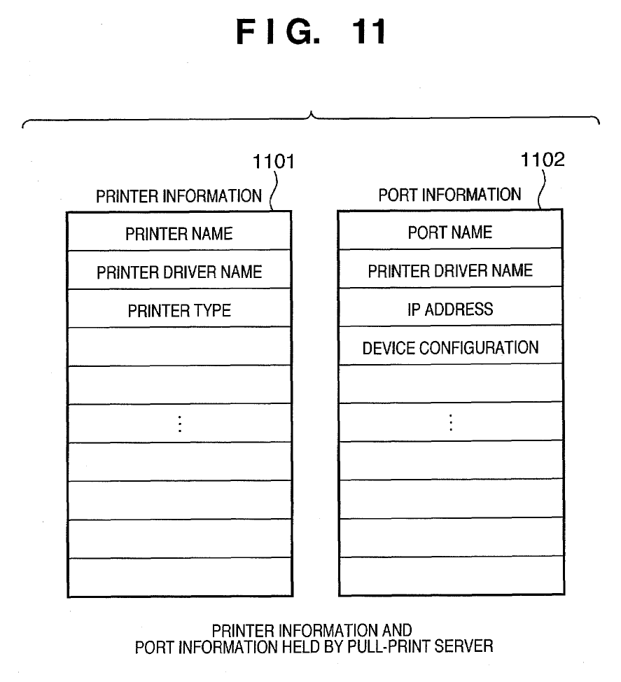

The pull-print server 305 comprises print queues 401 and 401A and output ports 402 and 402A corresponding in number to the print devices 306 and 306A. The pull-print server 305 manages the print queues 401 and 401A and the output ports 402 and 402A on the basis of pieces of information as shown in FIGS. 10 and 11.

The output ports 402 and 402A are associated with the IP addresses of corresponding print apparatuses or names used in the DNS (Domain Name System). A job scheduling request destination and job transmission destination are specified on the basis of the IP address or name, transmitting (outputting) the job.

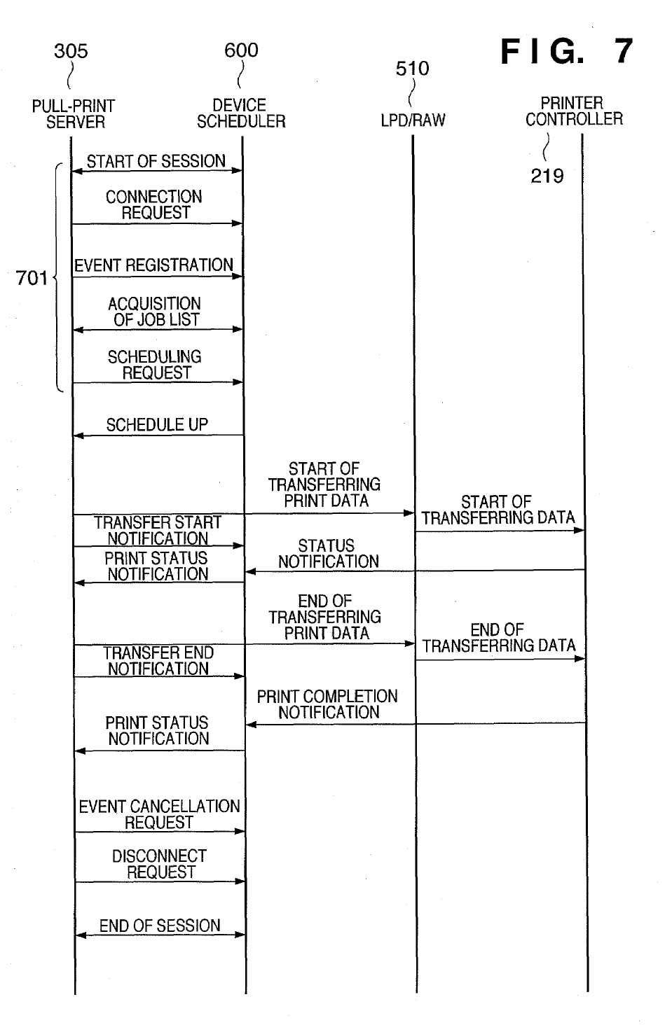

In printing, the application 301 designates a printer and issues a print instruction. The job control port monitor 304 delivers, to the pull-print server 305, a print job which is generated by the PDL driver 302 on the basis of the print instruction. When the print job is pull-print, the pull-print server 305 holds the print job in the print queue 401 (for pull-print). When the print job is normal print, the pull-print server 305 holds the print job in the print queue 401A (for normal print), and instructs the output port 402 to accept the print job. That is, immediately when registering the print job in the queue, the pull-print server 305 issues a scheduling request (701 in FIG. 7). The output port 402 accepts the print job. A user can set, through a user interface provided by the PDL driver, whether the print job is pull-print or normal print.

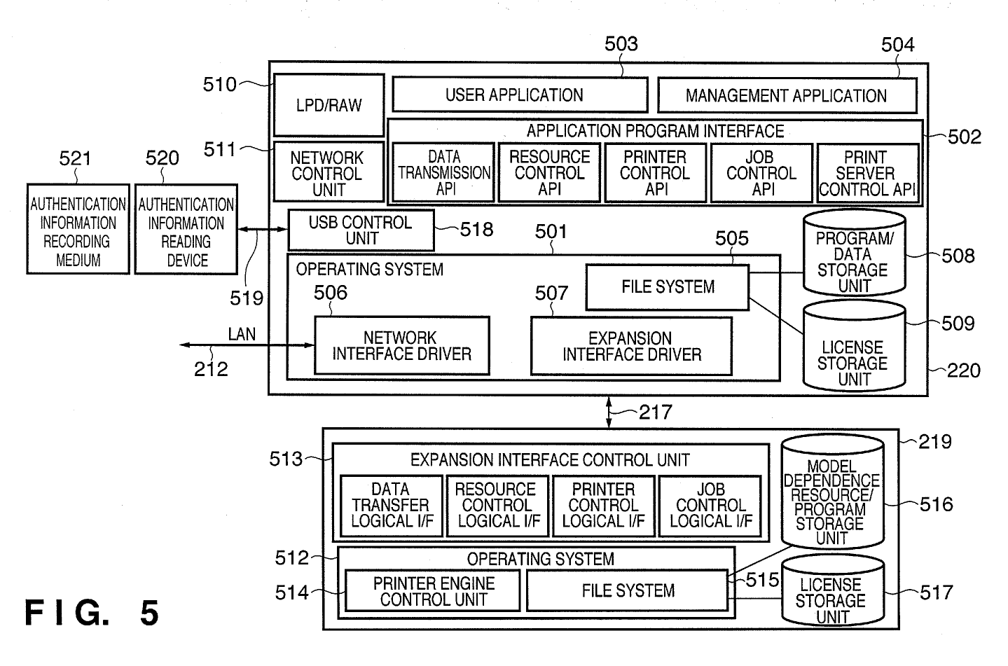

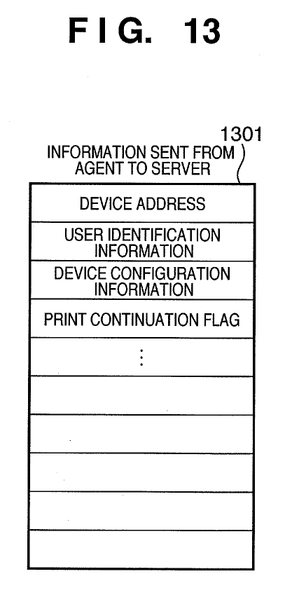

The pull-print agent 606 (FIG. 6) detects predetermined information read from the authentication information recording medium 521 (FIG. 5), which will be described in detail later. In accordance with the detection, the pull-print agent 606 sends, to the pull-print server 305, information 1301 (FIG. 13) containing user identification information and a device address. The user identification information means information for identifying a specific individual or information for identifying a department. This information is, e.g., text data or bit data. When there is one or a plurality of jobs containing or associated with user identification information, the pull-print server 305 issues a scheduling request to the print device 306 corresponding to the device address. More specifically, the pull-print server 305 issues a scheduling request to the device scheduler of the target print device (FIG. 7). The device scheduler of the print device 306 schedules jobs accepted from a plurality of pull-print servers 305 on the basis of the scheduling function of the device scheduler, and issues a print instruction to each pull-print server 305. Upon receiving the print instruction, the pull-print server 305 outputs print data to the print device 306 via the output port 402.

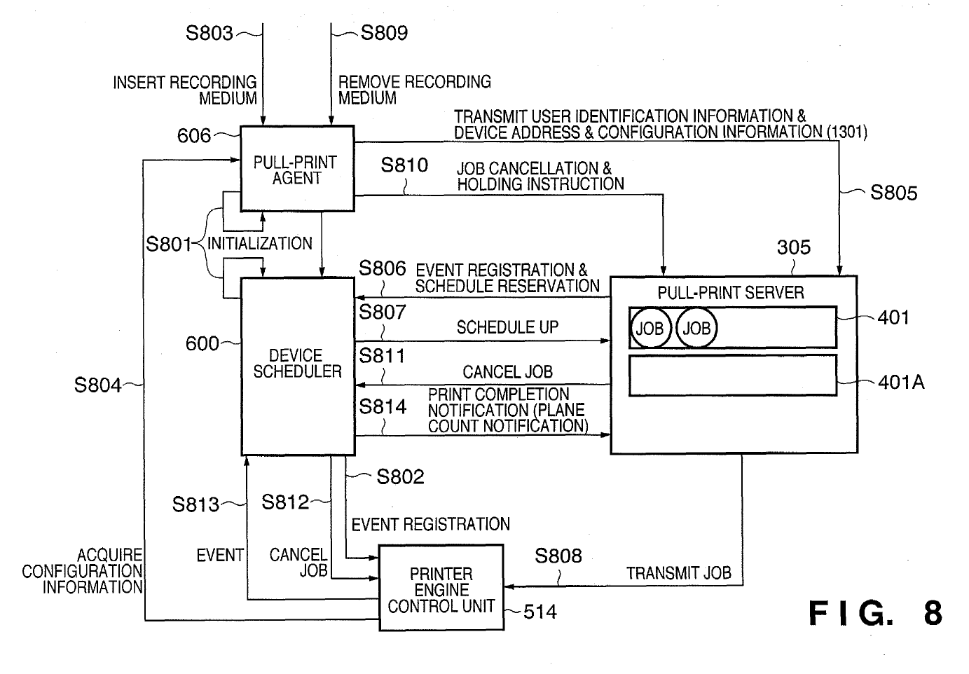

If the pull-print agent 606 cannot detect the presence of the authentication information recording medium 521 during printing, the pull-print server 305 instructs the print device 306 to cancel the print job (S2202 in FIG. 22 to be described later). The device scheduler cancels the print process in accordance with the instruction, and notifies the pull-print server 305 of the job progress (e.g., the number of printed/discharged planes) (S814 in FIG. 8). In correspondence with the print job, the pull-print server 305 holds the job status information (the number of printed or discharged planes) based on the notified progress. The job status information is information for identifying how much of the print job has been printed. In other words, the job status information may be re-output pages or printed pages as far as the pull-print server 305 can identify the re-output start page of the print job. When the pull-print agent 606 detects the authentication information recording medium 521 again, the pull-print server 305 starts outputting the job from a print plane number held in correspondence with the user identification information sent from the pull-print agent.

FIG. 5 is a block diagram for explaining the software configurations of control programs stored in the storage devices of the network print server 220 and printer controller 219 in the print device 306 of the print system according to the first embodiment. The software configurations in FIG. 5 represent main parts of the present invention, and in practice, the control programs include other software configurations for performing a printout process. The CPU (CPU 201 or 208) of each control device analyzes and processes each control program shown in FIG. 5.

An operating system 501 supervises basic data input/output control of the network print server 220. The operating system 501 incorporates a file system 505, expansion interface driver 507, and network interface driver 506. The file system 505 controls input/output to/from a program/data storage unit 508 and license storage unit 509. The expansion interface driver 507 controls communication with the printer controller 219 via the expansion interface 217. The network interface driver 506 controls the LANC 205 to communicate with an external device such as a host computer (not shown) via the communicate medium of the local area network (LAN) 212.

An application program interface (API) 502 provides various functions of the operating system to an application program. Examples of the application program are a user application 503 running on the network print server 220, and a management application 504 for registering and managing a print device 306 and user application. The application program interface 502 provides the following functions (APIs). That is, a data transmission API provides a print data transmission/reception function. A resource control API controls input/output of resource data such as a bitmap image and display message. A printer control API controls reactivation of the print device 306, initialization and setting of set values, and the like. A job control API controls cancellation of a print job, a reprint instruction, and the like. A print server control API performs reactivation of the network print server 220, initialization and setting of set values, and activation, registration, and deletion of an application program.

An operating system 512 of the printer controller 219 supervises various process control operations of the printer controller 219. The operating system 512 incorporates a printer engine control unit 514 and file system 515. The printer engine control unit 514 controls communication with the printer engine 216. The file system 515 controls input/output to/from a model dependence resource/program storage unit 516 and license storage unit 517. The model dependence resource/program storage unit 516 stores a model dependence resource (e.g., a bitmap image or error message) referred to by the network print server 220, and a model dependence application program running on the network print server.

An expansion interface control unit 513 controls communication with the network print server 220 via the expansion interface 217. The expansion interface control unit 513 transfers, to the operating system 512, an instruction requested from the network print server 220 via each logical interface, and sends back the process result to the network print server 220. As logical interfaces of the expansion interface control unit 513, FIG. 5 shows a data transfer logical interface, resource control logical interface, printer control logical interface, and job control logical interface. The data transfer logical interface controls input/output of print data for each control type. The resource control logical interface controls input/output of various data stored in the model dependence resource/program storage unit 516. The printer control logical interface controls reactivation of the print device 306, initialization and setting of set values, and the like. The job control logical interface controls cancellation of a print job, a reprint instruction, and the like.

In the network print server 220, a USB control unit 518 acquires authentication information and presence status information of an authentication information recording medium from the authentication information recording medium 521 via an authentication information reading device 520 serving as an external device connected via a USB cable 519. The authentication information corresponds to the above-mentioned user identification information contained in a print job. The presence status information represents whether the authentication information recording medium 521 is inserted in the authentication information reading device 520. The presence or release of the authentication information recording medium 521 is also identifiable by physically detecting the authentication information recording medium 521 and using the detection signal as presence status information. By detecting the presence status information, a state incapable of inputting any user identification information, i.e., removal of the authentication information recording medium 521 is detectable.

The first embodiment employs the USB-connected authentication information reading device 520 and authentication information recording medium 521 as devices for detecting the presence of a user or specifying and authenticating a user. However, the present invention is not limited to this. For example, instead of the authentication information reading device 520 and authentication information recording medium 521, a contact type nonvolatile recording medium (e.g., IC card), detection of a user by infrared rays or the like, a vein authentication apparatus, a fingerprint authentication/reading apparatus, a retina authentication/reading apparatus, a voice authentication/reading apparatus, and the like are available as an authentication information acquisition device. Hence, the USB control unit 518 shown in FIG. 5 is not limited to “USB control”, and controls a connection protocol corresponding to a mounted authentication information acquisition device.

When the network interface driver 506 accepts notifications from the client PCs 101 to 103 via the LAN 212, a network control unit 511 accepts a reception notification. Based on this notification, the network control unit 511 can determine which pull-print server 305 communicates, and can control communication.

An LPD/RAW 510 is a module which controls a protocol used to accept print data transmitted by the pull-print server 305. The LPD/RAW 510 can deliver the accepted print data to the printer controller 219.

The user application 503 is stored in the model dependence resource/program storage unit 516 of the printer controller 219 or the program/data storage unit 508 of the network print server 220. When the print device 306 starts up, the CPU 201 compares a license held by the user application 503 stored in the program/data storage unit 508 or model dependence resource/program storage unit 516 with a license held in the license storage unit 509 or 517, and determines whether these licenses coincide with each other. If so, the CPU 201 determines that the application program is authentic, and loads the application program into the RAM 202 of the network print server 220.

The software configurations of a device scheduler 600 and the pull-print agent 606 which implement pull-print according to the first embodiment will be explained with reference to FIG. 6.

The device scheduler 600 and pull-print agent 606 correspond to the user application 503 on a device, and have the scheduling function of the print system and a management function of managing a print job accepted from the pull-print server 305.

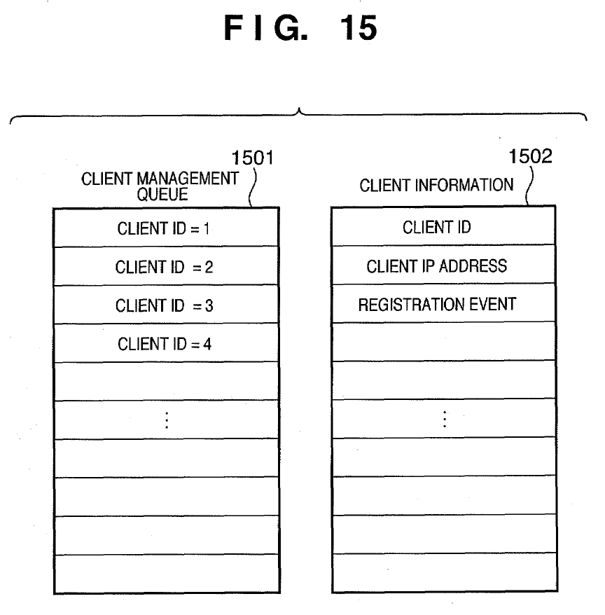

A communication connection management unit 601 manages the connection statuses of the client PCs 101 to 103, and information to be sent to the pull-print server 305. The communication connection management unit 601 uses a client management queue 1501 to manage client information 1502 (FIG. 15) representing connected clients. The communication connection management unit 601 communicates with the pull-print server 305 via the data transmission API of the application program interface 502 and the network interface driver 506.

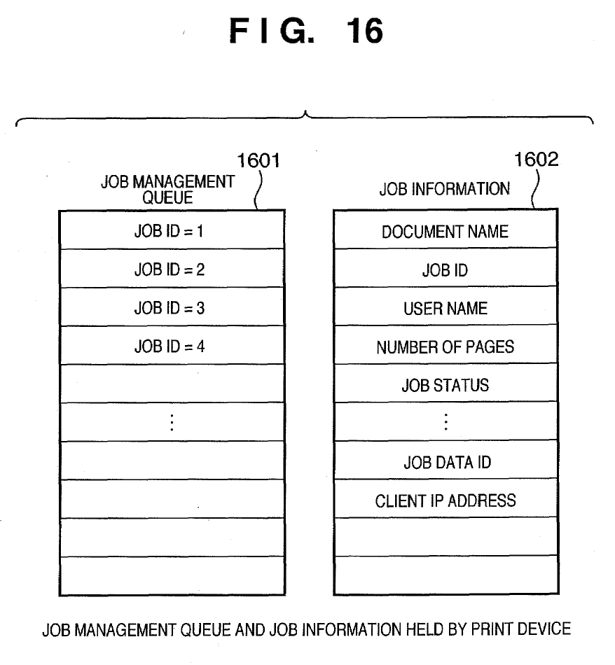

A schedule management unit 602 schedules print jobs accepted from the pull-print servers 305 of the client PCs 101 to 103. The schedule management unit 602 has a job management unit 603 and device management unit 604. The job management unit 603 manages a scheduling request issued from the pull-print servers 305 of the client PCs 101 to 103 and a job the pull-print server 305 requests to print. The job management unit 603 uses a job management queue 1601 (FIG. 16) to manage information (job information 1602 in FIG. 16) on a job the pull-print server 305 requests to print. The device management unit 604 accepts, from the printer controller 219 via an event handler 605, information (event) representing the status of a printer or that of an accepted print job. The device management unit 604 notifies the communication connection management unit 601 and job management unit 603 of the event accepted from the printer controller 219.

The pull-print agent 606 comprises a USB management unit 607, server communication unit 608, and device management unit 609. The USB management unit 607 acquires authentication information (user identification information) via the USB control unit 518, and delivers it to the server communication unit 608. The device management unit 609 acquires address information of the print device and the like, and delivers them to the server communication unit 608. The server communication unit 608 transmits the acquired information to the pull-print server 305.

FIG. 7 is a chart showing a process when the pull-print server 305 of each of the client PCs 101 to 103 accepts authentication information from the pull-print agent 606 and issues a scheduling request to the print device 306 until printing is complete.

Upon accepting authentication information, the pull-print server 305 starts session connection with the device scheduler 600. After the start of session connection, the pull-print server 305 transmits, to the device scheduler 600, a connection request to notify the device scheduler 600 of representing client information of the pull-print server 305 (including the contents represented by the client information 1502 in FIG. 15). The pull-print server 305 requests the device scheduler 600 to register an event in order to notify the pull-print server 305 of a job/device status. The pull-print server 305 issues a job list acquisition command to acquire job information whose schedule is managed by the device scheduler 600, and acquires the job list. When accepting the connection request, the device scheduler 600 registers the contained client information 1502 (FIG. 15) in the client management queue 1501 (FIG. 15). When accepting the event registration request, the device scheduler 600 sets it in the registration event of corresponding client information 1502 (FIG. 15). Upon accepting the job list request, the device scheduler 600 transmits, as a job list, the list of the job information 1602 registered in the job management queue 1601 (FIG. 16) to the pull-print server 305.

Then, the pull-print server 305 issues a scheduling request command to reserve printing. The scheduling request contains job information 1002 (FIG. 10) of a target print job. A “job ID” is set as one which is generated by the device scheduler 600 and sent back in accordance with the “scheduling request” in FIG. 7.

When accepting the scheduling request, the device scheduler 600 registers the job information 1602 (FIG. 16) in the job management queue 1601 (FIG. 16). The job ID in FIG. 16 coincides with or corresponds to that in FIG. 10, and is issued from the job management unit 603. The job information 1602 contains information such as a document name. The device scheduler 600 determines whether the print device 306 has become able to accept print data (the determination method will be described later). If the device scheduler 600 determines that the print device 306 has become able to accept print data, it specifies a job to be processed in accordance with the job management queue 1601, and issues schedule up of the job to the pull-print server that requested the job. Both the client information 1502 and job information 1602 record a “client IP address”. By referring to the client IP address, it can be determined which of pieces of client information registered in the client management queue 1501 corresponds to the job requesting client. The issued schedule up prompts the pull-print server 305 to start transmitting print data. After issuing schedule up, the device scheduler 600 updates the job status in the job information 1602 of the job to “schedule up”.

Upon accepting schedule up, the pull-print server 305 starts transferring print data to the LPD/RAW 510, and after the start of transfer, notifies the device scheduler 600 of it. Upon receiving the transfer start notification, the device scheduler 600 updates the job status in the job information 1602 of the job to “during transfer”.

Upon accepting the print data, the LPD/RAW 510 transfers the data to the printer controller 219. The printer controller 219 starts printing on the basis of the data transferred from the LPD/RAW 510. After printing starts, the printer controller 219 notifies the device scheduler 600 of the print status of the job. The device scheduler 600 notifies the pull-print server 305 of the print status of the job on the basis of registration event information of the client information 1502 (FIG. 15).

After the end of transferring the print data to the LPD/RAW 510, the pull-print server 305 transmits a transfer end notification to the device scheduler 600. Upon receiving the transfer end notification, the device scheduler 600 updates the job status of the job information 1602 to “transferred”.

When the printer controller 219 ends the print process, it notifies the device scheduler 600 of the completion of printing as the print status of the job. The device scheduler 600 notifies the pull-print server 305 of the completion of printing the job on the basis of registration event information of the client information 1502 (print status notification).

After confirming the completion of printing from the print status notification representing the completion of printing the job, the pull-print server 305 does not require any notification from the print device. For this reason, the pull-print server 305 issues an event cancellation request to cancel the registration event associated with the event notification from the device scheduler 600. Upon accepting the event cancellation request, the device scheduler 600 sets, in the registration event of the client information 1502, information that no event is announced.

The pull-print server 305 issues a disconnect request to end connection with the device scheduler 600, thereby ending the session. Upon accepting the disconnect request, the device scheduler 600 deletes the corresponding client information from the client management queue 1501, and ends the session with the pull-print server 305.

FIG. 8 is a view showing the schematic operation of the first embodiment. The schematic operation of the print system according to the first embodiment will be explained with reference to FIG. 8.

In S801, the tasks of the pull-print agent 606 and device scheduler 600 are initialized. During the initialization process, the device scheduler 600 registers an event (event registration) in the printer engine control unit 514 (S802). This process is to notify the pull-print server 305 via the device scheduler 600 of a change of the job status when processing a job in the printer engine 216, a change of the device status such as generation of an error (e.g., a jam or opening of the cover) in the printer, and the like. As described above, the device scheduler 600 enters a loop to wait for an event upon completing the initialization process. The pull-print agent 606 also enters the loop to wait for an event upon completing the initialization process.

If the pull-print agent 606 detects that the authentication information recording medium 521 is inserted into the authentication information reading device 520, it reads authentication information recorded on the authentication information recording medium 521 (S803). An authentication mechanism (not shown) specifies the owner of the card (authentication information recording medium 521), and obtains user identification information. The pull-print agent 606 acquires configuration information of the print device via the printer engine control unit 514 (S804). The configuration information acquired at this time includes consumable information (e.g., the remaining amount of sheets or the presence/absence of toner), and apparatus information (e.g., whether a double-sided unit or stapling apparatus (finisher) is available).

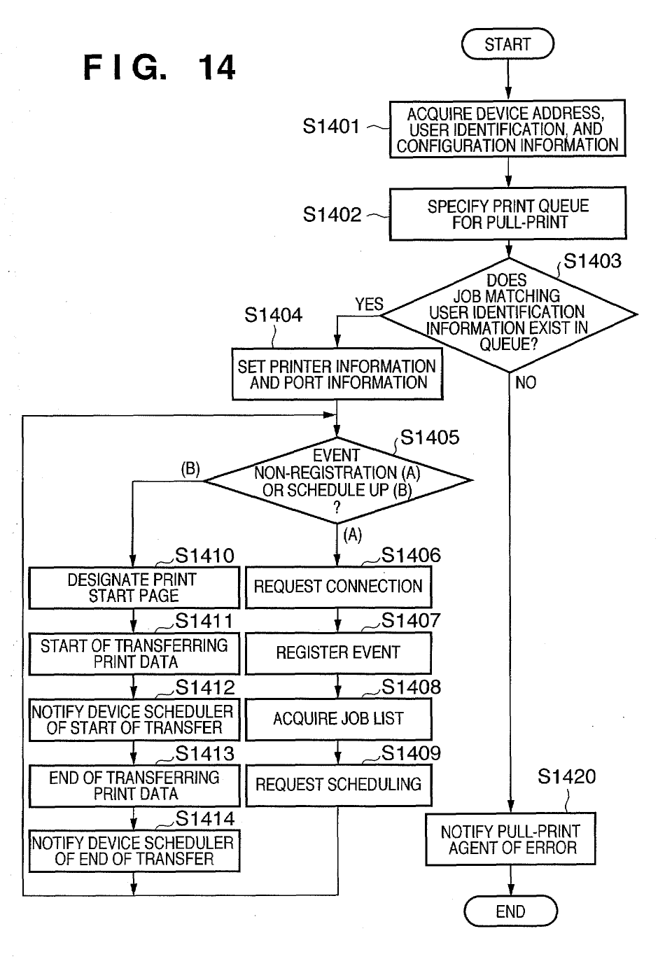

The pull-print agent 606 notifies the pull-print server 305 of the user identification information acquired in S803 and the device configuration information acquired in S804 (S805). The first embodiment defines this notification as a session initiation notification. Upon receiving the session initiation notification, the pull-print server 305 selects a printable job from the user identification information and device configuration information. This process will be described with reference to FIG. 14.

In order to print, the pull-print server 305 performs event registration and job schedule reservation (S806). The event registration has been described with reference to FIG. 7. Schedule reservation will be described with reference to FIG. 14. The pull-print server 305 receives schedule up from the device scheduler 600 (S807). Details of a process by the pull-print server 305 upon receiving schedule up will be described with reference to FIG. 22. Upon receiving schedule up, the pull-print server 305 reads, from the pull-print queue, one or a plurality of print jobs corresponding to the user identification information notified in advance, and outputs the read print jobs to the printer engine control unit 514 (S808). More specifically, the pull-print server 305 transfers print data to the LPD/RAW 510, which develops the print data into an image and transfers the image to the printer controller 219.

If the pull-print agent 606 detects that the authentication information recording medium 521 is removed and no user identification information can be input (S809), it sends a notification corresponding to that detection to the pull-print server 305 (S810). For example, the pull-print agent 606 issues a cancellation instruction and job holding instruction to the pull-print server 305 as a notification corresponding to detection of removal of the authentication information recording medium 521. FIG. 8 shows the “job cancellation & holding instruction”, but the notification contents are not limited to this. The pull-print agent 606 may notify the pull-print server 305 of information representing removal of the authentication information recording medium 521 as far as the notification allows the pull-print server 305 to determine whether to control a print job. In accordance with the notification from the printer in S810, the pull-print server 305 issues a cancellation instruction as a job control instruction to the device scheduler 600 (S811). Upon receiving the job cancellation instruction, the device scheduler 600 issues a job cancellation instruction to the printer engine control unit 514 (S812). Upon receiving the job cancellation instruction, the printer engine control unit 514 cancels the job by ending the process associated with printing in progress. After canceling the job, the printer engine control unit 514 issues an event to notify the device scheduler 600 of cancellation of the job (S813). After receiving the job cancellation notification from the printer engine control unit 514, the device scheduler 600 notifies the pull-print server 305 of the number of print planes having undergone printing and discharge (S814). If the notified number of print planes is smaller than the total number of planes of the job, the pull-print server 305 holds the job so as to print later. Details of this process will be described with reference to the flowchart of FIG. 22.

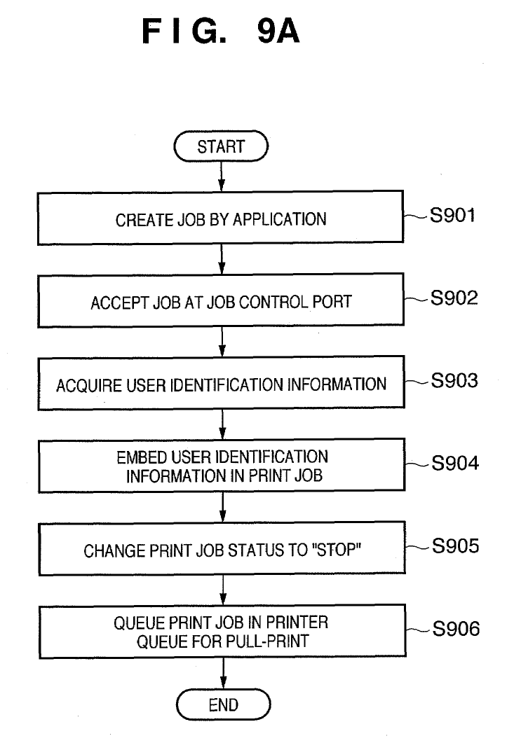

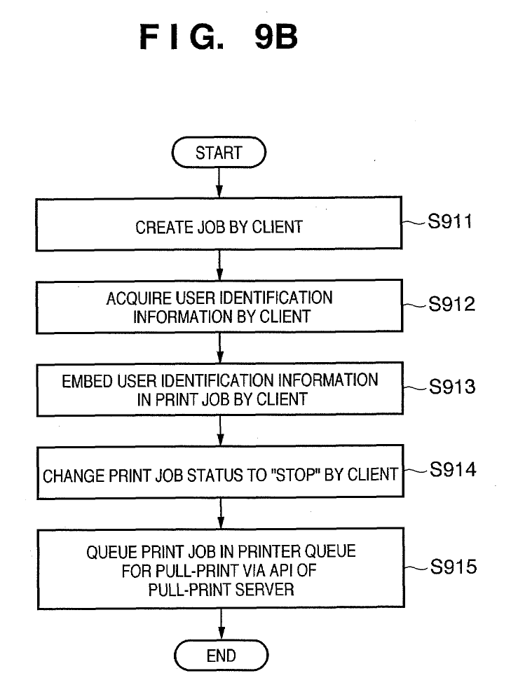

FIGS. 9A and 9B are flowcharts for explaining a process to register a pull-print job in the pull-print server 305.

FIG. 9A shows a process to register a job from the application 301. In S901, the application 301 creates a job, designates a printer, and issues a print instruction. In S902, the PDL driver 302 generates a print job on the basis of the print instruction, and delivers the print job to the job control port monitor 304 via the spooler 303. The job control port monitor 304 delivers the print job to the pull-print server 305. The pull-print server 305 executes the processes in S903 to S906.

More specifically, the pull-print server 305 acquires user identification information in S903, and embeds it in the print job in S904. In the first embodiment, the pull-print server 305 generates job information 1002 corresponding to the print job, and describes the user identification information in the job information 1002. The user identification information is identical to authentication information recorded on the authentication information recording medium 521. In the first embodiment, authentication information is obtained by providing a GUI (not shown) and prompting a user to input information. A card reader may read identification information from an IC card holding it, thereby using the identification information as user identification information.

In S905, the pull-print server 305 changes the job status to “stop”. In step S906, the pull-print server 305 queues the “stop” job in the print queue 401 for pull-print.

According to the job registration method, the application 301 registers a job, but the job registration application 309 can also register it. In this case, the job registration application 309 may exist in a client PC different from the pull-print server 305, as shown in FIG. 3. As the job registration application 309, for example, an application which outputs form print data, or a catalogue output application which outputs catalogue print data is applicable.

FIG. 9B is a flowchart for explaining a process to register a job from the job registration application. In S911, the job registration application 309 selects a print job created using a PDL driver. The job registration application 309 acquires user identification information in S912, and embeds it in the selected print job in S913. For example, the user identification information is described as “user identification information” of the job information 1002. The user identification information is identical to authentication information recorded on the authentication information recording medium 521.

In S914, the job registration application 309 changes the job status to “stop”. In step S915, the job registration application 309 queues the job via an API 610 in the print queue 401 for pull-print.

By the above-described registration process, a plurality of print jobs created by a specific user contain common user identification information. The user directly inputs the user identification information via a predetermined user interface, but the user identification information management method is not limited to this. For example, a user ID recorded on a memory card may be read out and used as user identification information. It is also possible to manage a user ID in correspondence with user identification information used for pull-print in the first embodiment, acquire user identification information corresponding to a designated user ID, and associate the user identification information with a print job. In the first embodiment, the user identification information designates a print job in pull-print. In the above-mentioned registration, user identification information is embedded in a print job (job information) and associated with print information, but may be associated using link information.

FIG. 10 is a view showing an example of the data structure of the job information 1002 added to a scheduling request issued from the pull-print server 305 in order to print, and an example of the data structure of a job management queue 1001 used to manage pieces of job information by the pull-print server 305. The pull-print server 305 holds the job management queue and job information shown in FIG. 10. The job management queue 1001 shown in FIG. 10 manages not job information itself, but a job ID indicating a link to the job information. The job management queue 1001 corresponds to the print queues 401 and 401A in FIG. 8.

The job information 1002 is print job information added to a scheduling request issued to start printing by the pull-print server 305. In the job information 1002, the “document name” represents the document name of a print job, and the “job ID” represents a job ID issued by the job management unit 603. The job ID is sent from the device scheduler 600 to the pull-print server 305 in accordance with a scheduling request described with reference to FIG. 7 and the like, and managed by the pull-print server 305. The “user name” represents the name of a user who starts printing in a client. The “number of pages” represents the number of pages of a job, and the “job status” represents the status of a print job. The “job holding flag” represents whether to hold a job when canceling it. As the “reprint start page”, the start page when reprinting a job is registered on the basis of job progress information representing a page to which an interrupted print job is complete. By restarting printing from the reprint start page, the interrupted print job can restart from the interrupted position. In first printing, the “reprint start page” is 0. The “user identification information” has been described above.

The “reprint start page” corresponds to job status information calculated on the basis of information representing the print progress in S814 of FIG. 8. However, the job progress information is not limited to the “reprint start page”. The job progress information may adopt another information as far as the printer inputs user identification information again and the output start page of the print job read in correspondence with the input user identification information can be specified. For example, it is also possible to directly store notification information (job progress information) in S814 instead of the “reprint start page”, and after inputting user identification information again, calculate a reprint start page on the basis of the stored notification information.

When no authentication information recording medium 521 can be detected and job cancellation is executed (S2202 to be described later), the job holding flag of the job information 1002 is set ON to hold the job in the pull-print server 305. At this time, the device scheduler 600 notifies the pull-print server 305 of printed pages upon cancellation of the job. The pull-print server 305 increments the notified value by one, and sets the incremented value at the “reprint start page” of the job information 1002. If the authentication information recording medium 521 is detected again, the pull-print server 305 reprints the saved job. This reprinting starts from a page set at the “reprint start page”.

The “job status” represents a job status until no job remains in the printer after the pull-print server 305 issues a print scheduling request. The job status includes “during standby for printing”, “schedule up status”, “during transfer”, “transferred”, and “printed”.

The “job ID” is a job ID contained in print data, which is information added when the print device notifies the print server of the job status in the printer controller 219.

The job management queue 1001 is a management queue for managing pieces of job information 1002. Upon accepting a print request from a host application, the job management queue 1001 registers the job information 1002. At the end of printing a print job, corresponding job information is deleted from the job management queue 1001.

When a print scheduling request is issued, information on a designated output destination is also managed in association with the job management queue 1001 and job information 1002. FIG. 11 shows this state. FIG. 11 shows an example of the data structures of printer information 1101 and port information 1102 managed by the pull-print server 305.

The printer information 1101 represents pieces of print queue information managed by the pull-print server 305. The printer information contains information such as the “printer name”. The port information 1102 represents pieces of output port information managed by the pull-print server 305. The port information 1102 contains information such as the “IP address” of a print device.

After specifying a print queue and output port in S1402 to be described later, a device address in the information 1301 (FIG. 13) transmitted from the pull-print agent 606 is set at the “IP address” of the port information 1102. A device configuration in the information transmitted from the pull-print agent 606 is set at the “device configuration” of the port information 1102.

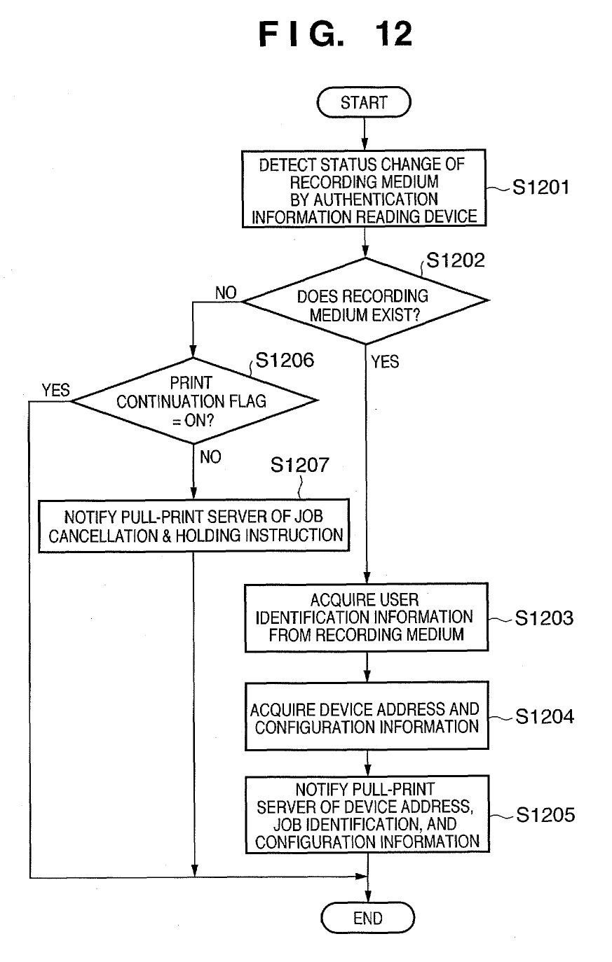

FIG. 12 is a flowchart showing a process until the pull-print agent 606 notifies the pull-print server 305 of information of the authentication information recording medium 521 necessary for pull-print after detecting authentication information.

The authentication information reading device 520 detects a status change of the authentication information recording medium 521. For example, when the authentication information reading device 520 is a card reader, a status change of the authentication information recording medium 521 means a change such as removal or insertion of the authentication information recording medium 521 (card). For example, when the authentication information reading device 520 uses an infrared sensor or the like to detect the authentication information recording medium 521, a status change of the authentication information recording medium 521 means whether the existence (presence/absence) of the authentication information recording medium 521 has changed. This also applies to an apparatus (authentication using the vein pattern of a palm) which authenticates a user when he puts his hand or the like over the authentication information reading device 520. In this case, the user keeps putting his hand over the authentication information reading device 520 during pull-print. In S1201, the pull-print agent 606 receives a detected status change of the authentication information recording medium 521 from the authentication information reading device 520.

If the authentication information reading device 520 detects a status change of the authentication information recording medium 521 and determines that the authentication information recording medium 521 exists, the process shifts from S1202 to S1203, and the pull-print agent 606 acquires authentication information (user identification information) from the authentication information recording medium 521. In S1204, the pull-print agent 606 acquires, from a print device, a device address for specifying it, and acquires device configuration information (S804 in FIG. 8). The acquired configuration information contains consumable information (e.g., the remaining amount of sheets or the presence/absence of toner), and apparatus information (e.g., whether a double-sided unit or stapling apparatus (finisher) is available). In S1205, the pull-print agent 606 notifies the pull-print server 305 of the identification information acquired in S1203 and the device address and device configuration information acquired in S1204 (S805).

If no authentication information recording medium 521 exists in S1202, it is determined that input of authentication information is released, and the process shifts to S1206. In S1206, the pull-print agent 606 branches the process on the basis of a print continuation flag. The print continuation flag is stored in advance in the authentication information recording medium 521. The authentication information reading device 520 reads the print continuation flag from the authentication information recording medium, and inputs the print continuation flag to the network printer 104. Note that, the print continuation flag may be set from the operation unit of the network printer 104. Alternatively, a print job may contain the print continuation flag, and the network printer 104 may read the contained print continuation flag.

If the print continuation flag is OFF, the process shifts to S1207. In S1207, the pull-print agent 606 notifies the pull-print server 305 of a print job cancellation & holding instruction (S810). As described in S810 of FIG. 8, the notification in S1207 suffices to allow the pull-print server 305 to determine whether to control the print job. For example, the notification may be information representing removal of the authentication information recording medium 521. If the print continuation flag is ON in S1206, the process ends without canceling the job in S1207.

FIG. 13 is a view showing an example of the data structure of information transmitted from the pull-print agent 606 to the pull-print server 305 in S1205. The information table 1301 registers information transmitted from the pull-print agent 606 to the pull-print server 305 after the authentication information reading device 520 detects the authentication information recording medium 521. The contents of the information table 1301 are the “device address”, “user identification information”, “device configuration information”, and “print continuation flag”.

The “user identification information” represents information used to specify a job subjected to pull-print. The first embodiment adopts the creator (user name) of a job associated with each job in order to specify a job subjected to pull-print, but the user identification information is not limited to this. A job ID or job name for uniquely identifying a job is also available.

An ON value of the “print continuation flag” represents a mode in which printing continues without canceling any job even if the authentication information reading device 520 cannot detect the authentication information recording medium 521 during printing. When the value of the “print continuation flag” is OFF (the default value is OFF), a job is canceled if the authentication information reading device 520 cannot detect the authentication information recording medium 521.

FIG. 14 is a flowchart for explaining a print data transfer process executed when the pull-print server 305 of each of the client PCs 101 to 103 accepts information shown in FIG. 13 from the pull-print agent 606.

In S1401, the pull-print server 305 acquires a device address, user identification information, and device configuration information (FIG. 13) from the pull-print agent 606. In S1402, the pull-print server 305 specifies the print queue 401. In S1403, the pull-print server 305 checks whether the print queue 401 (for pull-print) is queuing a job matching the user identification information. If the matching job is queued, the pull-print server 305 sets in S1404 the device address and device configuration information acquired in S1401 in the printer information 1101 and port information 1102 of FIG. 11, and the process shifts to S1405. If no matching job is queued, the process advances from S1403 to S1420, the pull-print server 305 notifies the pull-print agent 606 of an error, and the process ends.

In S1405, the pull-print server 305 determines whether the device scheduler 600 does not register any event or the pull-print server 305 has accepted, from the device scheduler 600, a schedule up command designating the start of transferring print data. If no event is registered, the process shifts to S1406. Whether no event is registered can be determined from whether an event registration process in S1407 has been executed. If the pull-print server 305 accepts a schedule up command, the process shifts to S1410.

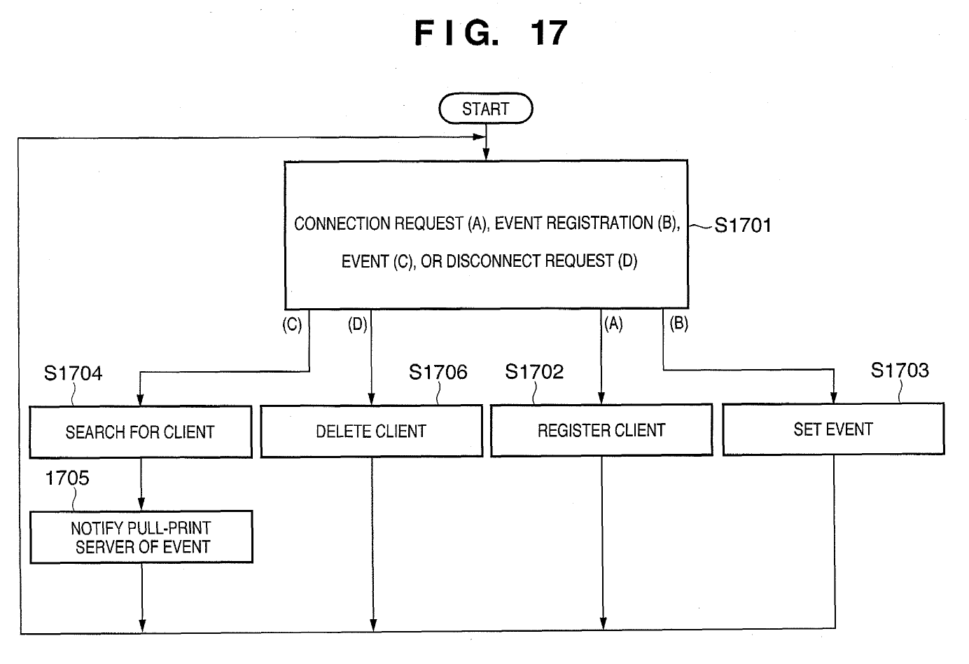

When no event is registered, the communication represented by 701 in FIG. 7 is performed. First, in S1406, the pull-print server 305 issues a connection request command to connect to the device scheduler 600. The connection request contains the IP address (client IP address) of the pull-print server 305. After the pull-print server 305 issues the connection request, the client management queue 1501 (FIG. 15) of the device scheduler 600 registers the information of the pull-print server 305 (to be described later with reference to FIG. 17). This registration allows the pull-print server 305 and device scheduler 600 to exchange information. Then, in S1407, the pull-print server 305 registers a job event and device event in the device scheduler 600. By this process, a necessary event is registered in the registration event of the client information 1502 corresponding to the pull-print server 305. After registering the job event, the device scheduler 600 notifies the pull-print server 305 of a status change of a job printed by the pull-print server 305 or a job printed by another client. After registering the device event, the device scheduler 600 notifies the pull-print server 305 of a status change of the print device 306.

In S1408, the pull-print server 305 acquires a list (job list) of job IDs registered in the job management queue 1601 managed by the device scheduler 600. The job list and job event allow the pull-print server 305 to grasp the job print status managed by the device scheduler 600. As a result of the above process, preparations for printing are complete. In S1409, the pull-print server 305 selects a print job matching the user identification information from the print queue for pull-print so as to register the job into the device scheduler of the print device specified by the device address. The pull-print server 305 transmits job information of the selected print job together with a scheduling request so as to register the selected print job in the device scheduler 600. The process returns to S1405 to wait for the next instruction. The scheduling request in S1409 makes the job management queue 1601 of the device scheduler 600 register and manage the target print job.

If the pull-print server 305 accepts, from the device scheduler 600, a schedule up command designating transfer of print data, the process shifts to S1410. In S1410, the pull-print server 305 sets, in the print job, the “reprint start page” of the job information 1002 of the target print job. In S1411, the pull-print server 305 starts transferring the designated job. Upon the start of transmitting print data, the pull-print server 305 notifies in S1412 the device scheduler 600 of the start of transfer (transfer start status). The transfer of print data ends in S1413, and the pull-print server 305 notifies in S1414 the device scheduler 600 of the end of transfer.

FIG. 15 is a view showing the client information 1502 and client management queue 1501 managed by the communication connection management unit 601 of the device scheduler 600.

The client information 1502 contains a “client ID” assigned to each connected client PC by the communication connection management unit 601, and a “client IP address” representing the IP address of the connected client PC. The client information 1502 also contains a “registration event” representing the type of event registered by the pull-print server 305 of the connected client PC. The event type represents the type of device status event or job status event issued by the printer controller 219.

The client management queue 1501 queues the client information 1502 of the connected pull-print server 305. When a session with a client starts, the management queue registers corresponding client information, and when the session is disconnected, corresponding client information is deleted from the management queue.

FIG. 16 is a view showing the job information 1602 added to a scheduling request issued by the pull-print server 305 for printing, and the job management queue 1601 which manages pieces of generated job information. The print device holds the job management queue 1601 and job information 1602.

The job information 1602 is print job information added to a scheduling request issued by the pull-print server 305 in order to start printing. The job information 1602 contains the “document name” of a print job, a “job ID” issued by the job management unit 603 of the device scheduler 600, a “user name” under which the pull-print server 305 starts printing, and the “number of pages” of the job. The job information 1602 contains a “job status” representing the status of a print job, a “job data ID” contained in print data transferred from the pull-print server 305, and a “client IP address” representing the IP address of the pull-print server 305 which requests to print that job.

The “job status” represents a status until no job remains in the printer after the pull-print server 305 issues a print scheduling request. The job status includes “during standby for printing”, “schedule up status”, “during transfer”, “transferred”, and “printed”. The “job data ID” is a job ID contained in print data, which is added when announcing a job status in the printer controller 219.

The job management queue 1601 is a management queue for managing pieces of job information 1602. When accepting a scheduling request from the pull-print server 305, the management queue registers the job information 1602. At the end of printing a corresponding print job, corresponding job information is deleted.

A process by the communication connection management unit 601 which processes a request and notification from the pull-print server 305, a notification from the device management unit 604, and a request and notification to the job management unit 603 will be explained with reference to the flowchart of FIG. 17.

In S1701, the communication connection management unit 601 accepts a notification or request from the pull-print server 305, device management unit 604, or job management unit 603, and determines the type of notification or request.

If the request or event accepted in S1701 is a connection request from the pull-print server 305, the process shifts to S1702. In S1702, the communication connection management unit 601 sets, in the client information 1502, a client ID issued by the communication connection management unit 601 and the IP address of the requesting pull-print server 305. Then, the communication connection management unit 601 registers the client information 1502 in the client management queue 1501. If the request or event accepted in S1701 is event registration from the pull-print server 305, the process shifts to S1703. In S1703, the communication connection management unit 601 sets, in the registration event of the client information 1502, an event type which is requested by the pull-print server 305 for registration and is to be announced. The event type includes a job event announcing a change of the job status, and a device event announcing a change of the device status.

If the request or event accepted in S1701 is a device event from the device management unit 604 or a job event from the job management unit 603, the process shifts to S1704. In S1704, the communication connection management unit 601 refers to settings of client information registration events in all pieces of client information 1502 registered in the client management queue 1501, and determines whether or not there is a pull-print server to be notified of the event. If the communication connection management unit 601 determines that there is a pull-print server to be notified of the event, it holds the IP address of the pull-print server, and transmits the event to all the pull-print servers to be notified of the event in S1705.

If the request or event accepted in S1701 is a disconnect request from the pull-print server 305, the process shifts to S1706. In S1706, the communication connection management unit 601 deletes the client information 1502 of the target pull-print server 305 from the client management queue 1501.

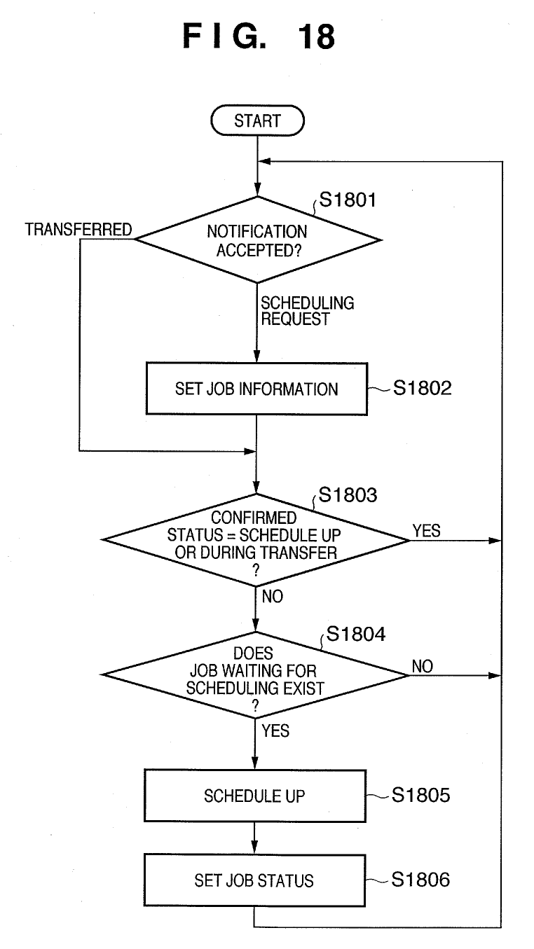

FIG. 18 is a flowchart for explaining a process by the schedule management unit 602 until it accepts a scheduling request from the pull-print server 305 and issues schedule up.

In S1801, the schedule management unit 602 accepts a notification from the pull-print server 305, and determines whether the notification is a scheduling request or a “transferred” status notification (transfer end notification in FIG. 7). If the notification is the scheduling request, the process shifts to S1802. In S1802, the schedule management unit 602 creates job information 1602 in which a job ID issued by the job management unit 603 and information added to the scheduling request are set. The schedule management unit 602 registers the scheduling request in the job management queue in the order in which scheduling requests are accepted, and the process advances to S1803. If the notification is the “transferred” status notification, the process advances from S1801 directly to S1803.

In S1803, the schedule management unit 602 confirms the job status of the job information 1602 registered in the job management queue 1601. If the job status represents “schedule up” or “during transfer”, an existing pull-print server is instructed to transfer print data, so the schedule management unit 602 returns the process to S1801. If the job status represents neither “schedule up” nor “during transfer”, the pull-print server 305 will not transfer print data. Hence, the process shifts to S1804, and the schedule management unit 602 prepares for issuing of schedule up. In S1804, the schedule management unit 602 confirms jobs in the job management queue 1601 in the order in which scheduling requests are accepted. If the schedule management unit 602 detects a job waiting for scheduling, the process shifts to S1805. In S1805, the schedule management unit 602 notifies a target client of schedule up to start transferring print data. In S1806, the schedule management unit 602 updates the job status of the job information 1602 to the schedule up status, and the process shifts to S1801.

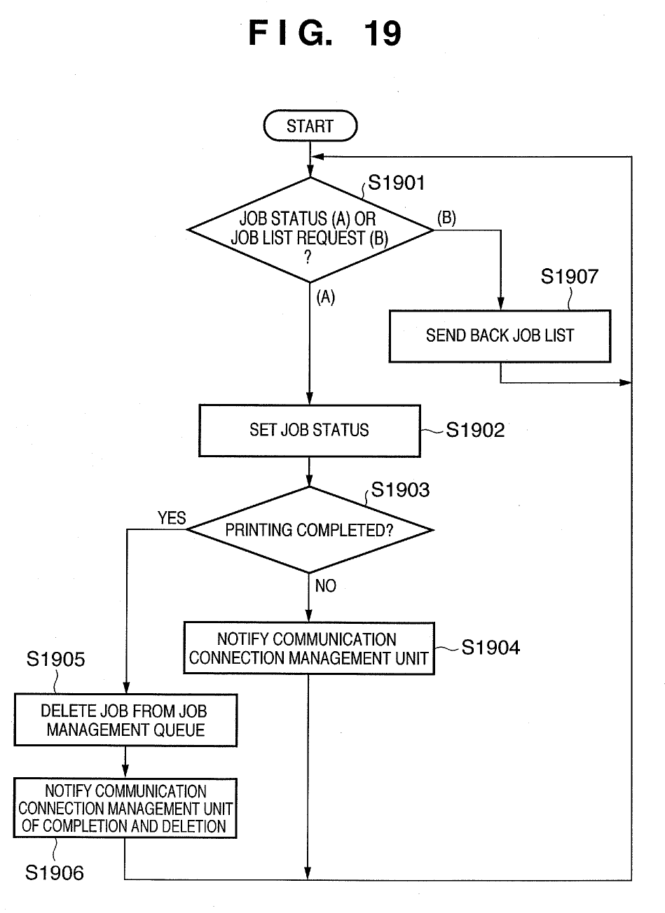

FIG. 19 is a flowchart showing a process by the job management unit 603 to acceptance of a job status notification event from the device management unit 604 and to acceptance of a job list request from the pull-print server 305.

In S1901, the job management unit 603 accepts a notification from the communication connection management unit 601 or device management unit 604, and determines whether the notification is a job status notification from the device management unit 604 or a job list request from the pull-print server 305.

If the job management unit 603 determines that the notification is a job status notification, the process shifts from S1901 to S1902, and the job management unit 603 updates the job status of corresponding job information. In the process of S1903, the job management unit 603 determines whether the job status notification is a print completion notification. If the job status notification is not a print completion notification, the process shifts to S1904, and the job management unit 603 notifies the communication connection management unit 601 of an instruction to issue the job status event to a client.

If the job status notification is a print completion notification in S1903, the process shifts to S1905. In S1905, the job management unit 603 deletes the target job from the job management queue. In S1906, the job management unit 603 notifies the communication connection management unit 601 of an instruction to issue the job completion event (notification of completion and deletion of job) to the pull-print server 305. After that, the process returns to S1901.

If the job management unit 603 accepts a job list request from the pull-print server 305 in S1901, the process advances to S1907. In S1907, the job management unit 603 notifies the communication connection management unit 601 of a job information list so as to transmit a list of pieces of job information 1602 registered in the job management queue 1601 to the requesting pull-print server 305.

As another embodiment, the device scheduler 600 may notify the pull-print agent 606 of a print page every time one page is printed. The pull-print agent 606 prints the print page on the authentication information recording medium 521. This process enables reprinting on the basis of the number of print planes recorded on the authentication information recording medium 521 even when failing to notify the pull-print server 305 of print plane count information due to that the print device is suddenly turned off or the network is disconnected.

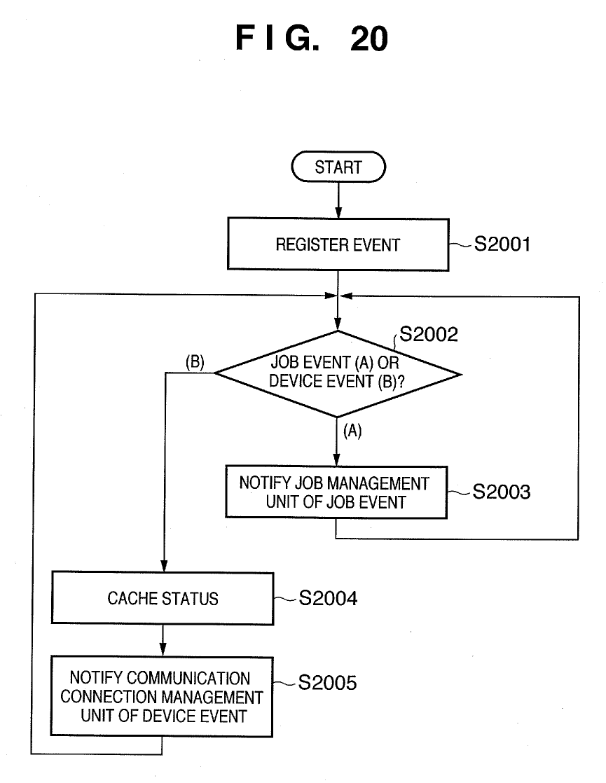

FIG. 20 is a flowchart showing a process by the device management unit 604 when accepting a device status or job status notification from the printer controller 219 via the event handler and notifying the job management unit 603 or communication connection management unit 601 of it.

When the device scheduler 600 starts up, the device management unit 604 registers an event in the printer controller 219 via the event handler in S2001 (S802). The device management unit 604 registers an event so as to notify a status of corresponding unit at a time when the device status changes or the status of a print job processed by the printer controller 219 changes.

In S2002, the device management unit 604 accepts, via the event handler 605, an event generated in the printer controller 219. After accepting the event, the device management unit 604 determines whether this event is a job event or device event. If the event is a job event, the device management unit 604 notifies the job management unit 603 of the job event in S2003. Then, the process shifts to S2002.

If the event is a device event, the process shifts to S2004, and the device management unit 604 holds the device status (status cache). In S2005, the device management unit 604 notifies the communication connection management unit 601 of the device event. Then, the process shifts to S2002.

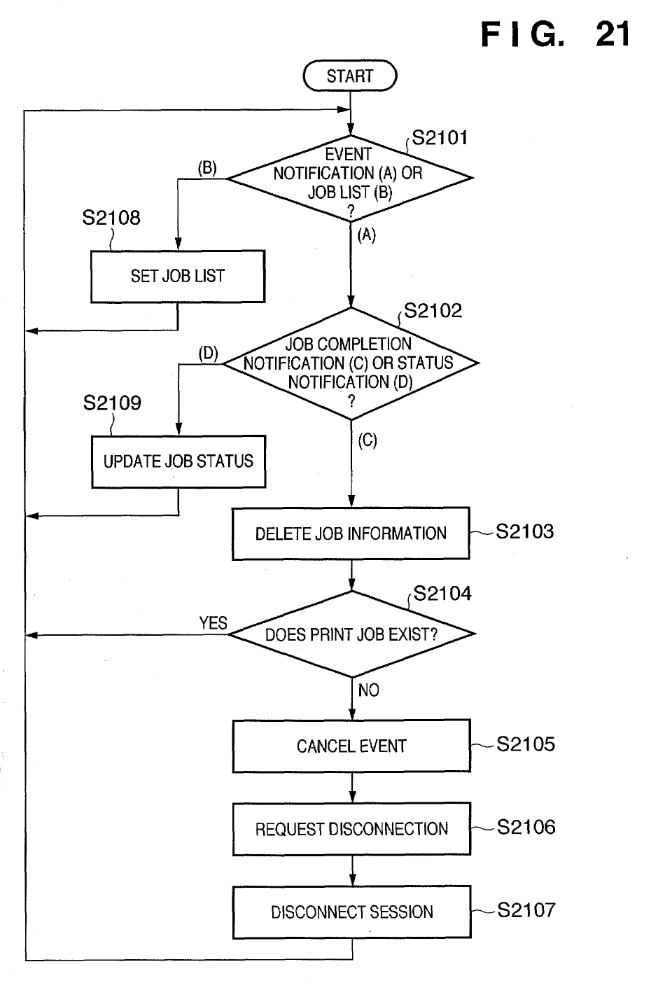

FIG. 21 is a flowchart showing a process by the pull-print server 305 when accepting a notification or command from the device scheduler 600.

In S2101, the pull-print server 305 determines whether it is notified of a job event from the device scheduler 600 or it receives a job list. If the pull-print server 305 is notified of a job event, the process shifts to S2102; if it receives a job list, to S2108. Upon receiving the job list, the pull-print server 305 sets, in S2108, job information obtained from the job list in the job information 1002 managed by the job management queue 1001 managed by the pull-print server 305.

In S2102, the pull-print server 305 determines whether the job event notification from the device scheduler 600 is a job completion notification or job status change notification (status notification). If the job event notification is a job status change notification (status notification), the pull-print server 305 updates the job status of corresponding job information 1002 in S2109.

If the accepted event notification is a job completion notification, the process advances from S2102 to S2103. In S2103, the pull-print server 305 deletes corresponding job information from the job management queue 1001. In S2104, the pull-print server 305 confirms whether an unprinted job remains in the job management queue 1001. If an unprinted job remains, the pull-print server 305 must exchange information with the device scheduler 600. To continue connection between the pull-print server 305 and the device scheduler 600, the process shifts to S2101. If there is no job of the client, the process shifts to S2105, and the pull-print server 305 starts a process to end connection with the device scheduler 600.

In S2105, the pull-print server 305 requests the device scheduler 600 to cancel a job event and device event registered at the start of connection. In response to this request, the device scheduler 600 deletes the contents of the event registration of the client information 1502. If there is no event registration information, the pull-print server 305 is not notified of any event even when the status of a job managed by the device scheduler 600 changes. In S2106, the pull-print server 305 issues a disconnect request to the device scheduler 600. When accepting the disconnect request, the device scheduler 600 deletes corresponding client information 1502 from the client management queue 1501. In S2107, the pull-print server 305 disconnects the session with the device scheduler 600. Then, the process returns to S2101, and the pull-print server 305 stands by.

FIG. 22 is a flowchart for explaining a process by the pull-print server 305 when receiving a notification corresponding to S810 (or S1207) from the pull-print agent 606. In S2201, the pull-print server 305 receives a job cancellation & holding instruction (notification corresponding to S810 (or S1207)) from the pull-print agent 606, and the process advances to S2202. In S2202, the pull-print server 305 instructs the device scheduler 600 to cancel a print job of user identification information corresponding to the notification received in S2201 (S811).

As described with reference to FIG. 8, the device scheduler 600, which is instructed to cancel the job, instructs the printer engine control unit 514 to cancel the job (S812). At the same time, the device scheduler 600 notifies the pull-print server 305 of the number of print planes representing the progress of the print job (S814). The notified number of print planes is the number of planes (=the number of pages) printed or discharged at the end of printing in accordance with the cancellation instruction. In S2203, the pull-print server 305 receives the print plane count notification from the device scheduler 600 (S814).

In S2204, the pull-print server 305 compares the print plane count information notified from the device scheduler 600 with the total number of planes of the job (the number of pages in the job information 1602). If the print plane count information coincides with the total number of planes of the job, the pull-print server 305 determines that printing of the job is complete, and sets the job holding flag in the job information 1002 to “OFF” in S2206. If the print plane count information does not coincide with the total number of planes of the job, the pull-print server 305 sets the job holding flag to “ON” in S2205 so as to reprint later. The job holding flag has been described with reference to FIG. 10. In S2207, the pull-print server 305 increments the notified number of print planes (number of printed planes) by one, and sets the incremented value in the reprint start page (job progress information) of the job information 1002. If the print queue 401 holds one or a plurality of jobs for which no schedule up is designated (YES in S2403), the pull-print server 305 executes a process to regard the progresses of these jobs to be 0 (regard the number of printed/discharged planes by the print device to be 0). The device scheduler 600, which is notified of cancellation, deletes the job and cancels event registration associated with the job (S1706).

In the description of the flowchart in FIG. 22, print job control by the pull-print server 305 is job cancellation, but is also applicable to another print job control. For example, the above-described control is also applicable to print job control to stop outputting a print job from the pull-print server 305 and suspend execution of the print job. It will readily occur to those skilled in the art that the flowchart in FIG. 22 is also applicable to the print job control for suspension.

As described above, the first embodiment discloses a print system in which a client PC (information processing apparatus) and print device (print apparatus) are communicable to each other. In this system, the pull-print server 305 holds one or a plurality of print jobs generated by the application 301 or the like, in a pull-print queue so as to read them on the basis of user identification information transmitted from the print device. The user identification information is identification information commonly assigned to print jobs generated by a given user, and is common to one or a plurality of print jobs. In the print device, the authentication information reading device 520 reads authentication information from the authentication information recording medium 521. The print device issues a request (S805 and S807) using the authentication information as identification information. The pull-print server 305 receives the issued request, reads one or a plurality of print jobs on the basis of the identification information contained in the received request, and outputs the read print jobs to the print device.

That is, according to the first embodiment, user identification information is saved in association with a job. The print apparatus inputs identification information, and the pull-print server is notified of it. A job corresponding to the identification information is downloaded from the pull-print server and printed out. Unlike a conventional pull-print system, a user need not directly designate a job from the print apparatus. For example, a head office registers a job associated with each user ID in the server every morning, and a user inserts his card into a card reader attached to a print apparatus. The print apparatus notifies the server of a user ID recorded on the card, allowing the user to print easily.

The first embodiment associates user identification information with a print job, and uses the user identification information to designate a print job in pull-print, but the user identification information is not limited to this. For example, user identification information may be commonly associated with a plurality of print jobs, and may be identification information itself assigned to a print job.

### Second Embodiment

In the pull-print system described in the first embodiment, a host computer, which made a print reservation, may go down or a communication error may occur when a print reservation arrives or while print data is transmitted. In this case, the print device 306 (network printers 104 and 105) may keep waiting for a transfer end notification from the host computer, and postpone a print data transmission process from another host computer. The second embodiment will describe an arrangement which solves this problem.

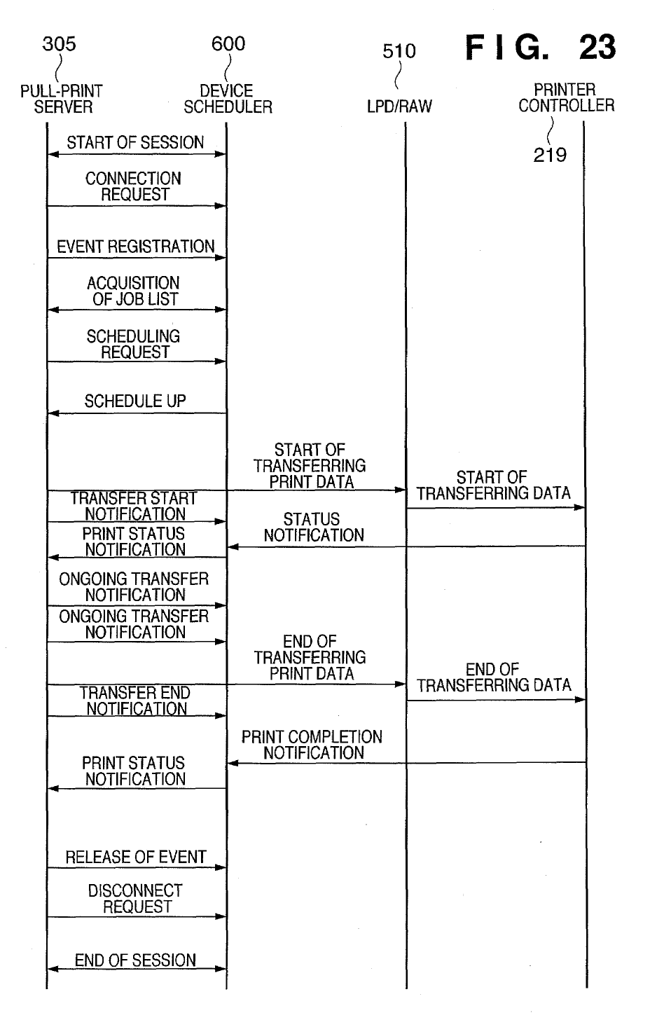

FIG. 23 is a chart showing a process until printing is complete after a pull-print server 305 accepts authentication information from a pull-print agent 606 and issues a scheduling request to a print device 306.

Procedures until the pull-print server 305 receives a print status notification from the device scheduler 600 after the start of a session between the pull-print server 305 and a device scheduler 600 are the same as those in FIG. 7.

As described with reference to FIG. 7, when transfer of print data starts, the device scheduler 600 notifies a client of a job print status on the basis of registration event information of client information. Further in the second embodiment, the pull-print server 305 issues to an ongoing transfer notification to the device scheduler 600 at a notification interval of the print data transferring status till the end of transferring print data. The notification interval of the print data transferring status may be contained in schedule up or set in advance by the system.

Procedures until the pull-print server 305 notifies an LPD/RAW 510 of the end of transferring print data and the session between the pull-print server 305 and the device scheduler 600 ends are the same as those in FIG. 7.

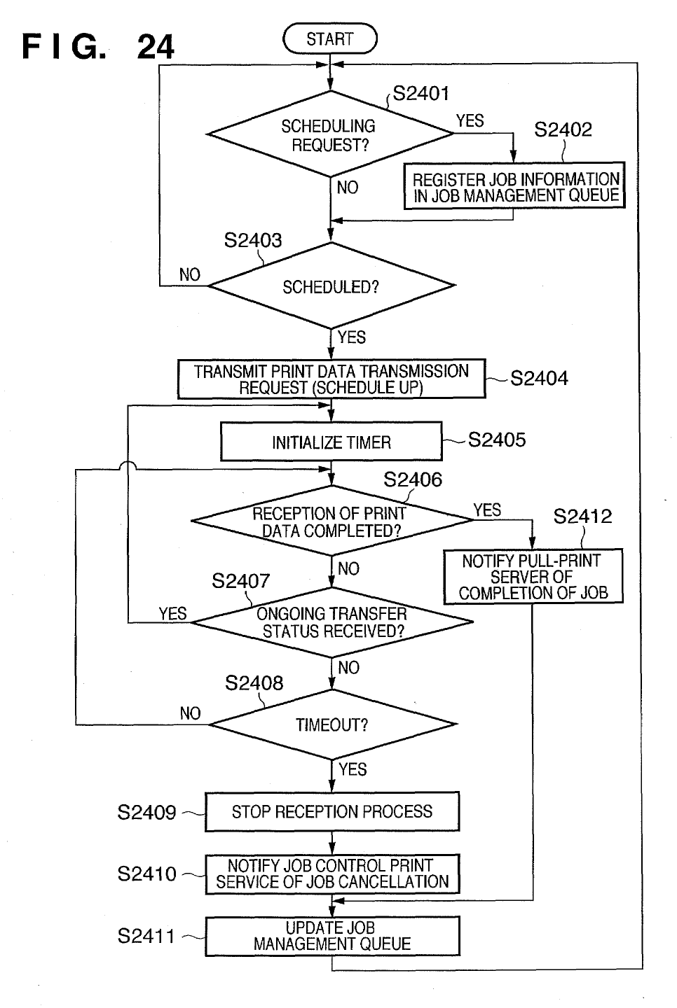

How to use the ongoing transfer notification by the device scheduler 600 will be explained. FIG. 24 is a flowchart showing a process by the device scheduler 600 until it completes a print process through schedule up after receiving a scheduling request from the pull-print server 305.

The device scheduler 600 receives scheduling requests from the pull-print server 305 of each of clients (PCs 101 to 103) in S2401, and registers job information at the end of a job management queue in S2402. In S2403, the device scheduler 600 determines whether there is job information registered in the job management queue. If the job information exists, the process advances to S2404. In S2404, the device scheduler 600 transmits a schedule up request to a client (pull-print server) which registers job information positioned at the top of the job management queue. The schedule up request contains a print data transmission request and notification interval information of the print data transferring status.

In S2405, the device scheduler 600 initializes and starts a timer for measuring the reception timeout of the print data transferring status. In S2406, the device scheduler 600 determines whether it has received a print data transfer end notification. If the device scheduler 600 has not received any transfer end notification, the process advances to S2407, and the device scheduler 600 determines whether it has received an ongoing transfer status (ongoing transfer notification) If the device scheduler 600 has received the ongoing transfer status, the process returns to S2405, and the device scheduler 600 initializes and starts again the timer. If the device scheduler 600 has not received any ongoing transfer status, the process advances from S2407 to S2408, and the device scheduler 600 determines the timeout of the timer. If no timeout occurs, the process returns to S2406. If a timeout occurs, the device scheduler 600 determines that the reception timeout of the transfer status occurs, and the process advances to S2409 to stop receiving the print data. In S2410, the device scheduler 600 notifies job control print services running on the clients (PCs 101 to 103) that the job is deleted (canceled). The process advances to S2411, the device scheduler 600 deletes the job information from the job management queue, and the process returns to S2401.

If the device scheduler 600 has received a print data transfer end notification in S2406, the process advances to S2412. In S2412, the device scheduler 600 notifies the pull-print server 305 of the completion of printing the job. In S2411, the device scheduler 600 deletes the job information from the job management queue, and the process returns to S2401.

According to the second embodiment, for example, if a host computer, which made a print reservation, goes down or a communication error occurs, the device scheduler 600 can recognize this by receiving an ongoing transfer notification. The second embodiment can solve the problem of postponing a print data transmission process from another host computer due to the communication error or the failure of the host-computer which is transmitting data.

### Third Embodiment

The first and second embodiments have described an arrangement of performing print job control such as cancellation or suspension of a job in accordance with whether the pull-print agent 606 detects authentication information (FIGS. 12 and 22). However, when authentication information from the authentication information recording medium 521 is detected, a print job may be controlled according to another modification. The third embodiment will explain this modification.

For example, when no authentication information recording medium 521 exists in S1202 of FIG. 12, it is considered that inputting of authentication information is released, and a pull-print server 305 is instructed to control a print job. However, in S1202, instead of determining whether the authentication information recording medium 521 exists, it may be detected whether authentication information from the authentication information recording medium 521 is detected newly or again. For example, when the authentication information recording medium is removed and then its insertion is detected again after a user is authenticated on the basis of authentication information, it may be considered that he cancels input of authentication information.

For example, in S803 of FIG. 8, an authentication information reading device 520 detects via wireless communication that a user puts the authentication information recording medium 521 over the vicinity of the authentication information reading device 520. At this time, the distance by which the authentication information reading device 520 can detect the authentication information recording medium 521 via wireless communication is set to about 10 cm. This setting reduces the possibility of erroneously detecting the authentication information recording medium 521 held by a person passing by the vicinity. This wireless communication can be implemented using the RFID technique and the like. Note that RFID stands for the radio frequency identification system.

Once the authentication information reading device 520 detects the authentication information recording medium 521, it does not detect the authentication information recording medium 521 again for a predetermined time. A user puts the authentication information recording medium 521 over the authentication information reading device 520 once, and after the lapse of the predetermined time, puts it over the authentication information reading device 520 again. This operation is equivalent to cancellation of input of authentication information of the authentication information recording medium 521 in the first and second embodiments. Once the authentication information reading device 520 detects authentication information from the authentication information recording medium 521 through wireless communication, the authentication information reading device 520 may consider that the authentication information is input again when becoming unable to detect it.

In this manner, various processes in the first and second embodiments can be achieved even by different methods of detecting authentication information from the authentication information recording medium 521.

### Fourth Embodiment

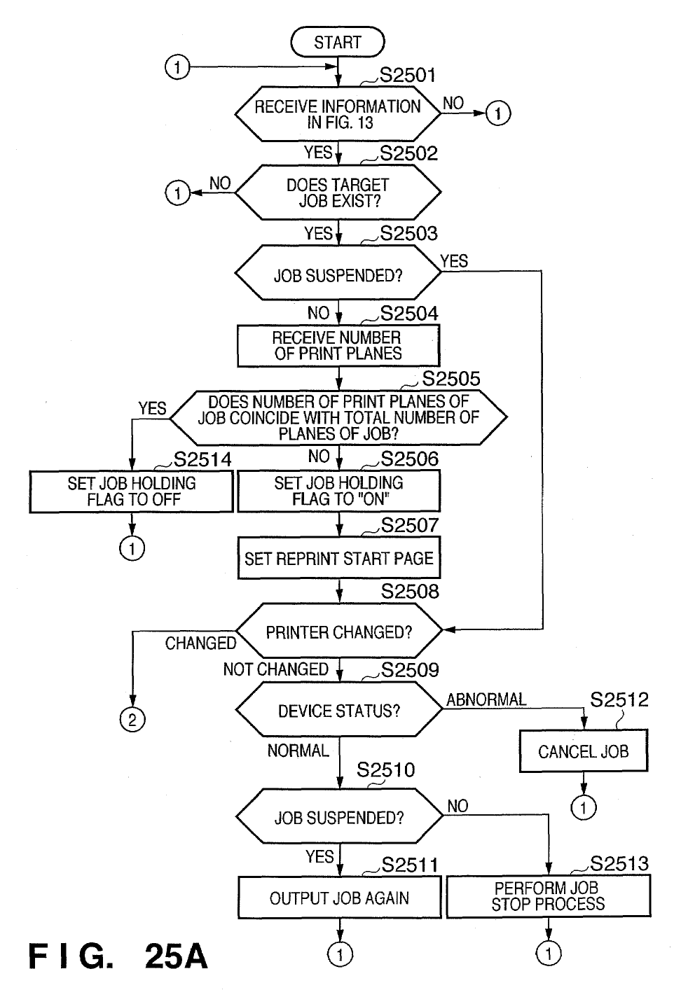

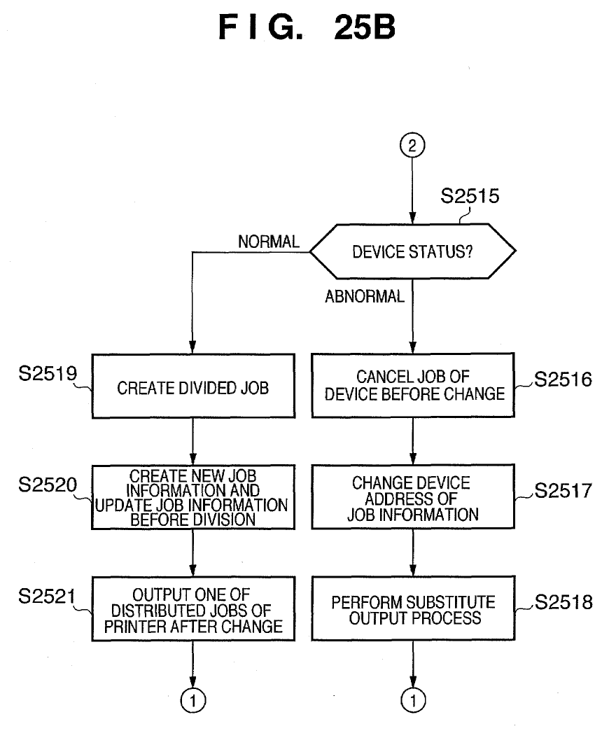

In the first to third embodiments, the pull-print server 305 performs print job control such as cancellation or suspension of a job in accordance with the detection status of authentication information by the pull-print agent 606. However, the pull-print agent 606 and pull-print server 305 can cooperate with each other to perform various print job control operations. Concrete examples of the print job control will be explained with reference to the flowcharts of FIGS. 25A and 25B.

Processes in steps of FIGS. 25A and 25B start when a pull-print server 305 executes processes in S1406 to S1409 described with reference to FIG. 14, issues at least a scheduling request, and then executes print job control. These processes are also executed while a print job is output after processes in S1410 and subsequent steps (after reception of schedule up) in FIG. 14.

<Flowchart in FIG. 25A>

In S2501, the pull-print server 305 determines whether it has received information as shown in FIG. 13. The information in FIG. 13 corresponds to information sent from a pull-print agent 606 to the pull-print server 305 when an authentication information reading device 520 detects an authentication information recording medium 521, as described in the first embodiment. For example, processes in S2502 and subsequent steps start when the authentication information recording medium 521 is recognized again after recognized once.

In S2502, the pull-print server 305 checks whether a print queue 401 (for pull-print) queues a job matching user identification information shown in FIG. 13, similar to S1403 described in the first embodiment. At this time, both the number of print jobs to be searched and that of detected print jobs may be one or more. If the print queue 401 does not queue any job matching the user identification information, the process returns to the determination process in S2501. If the print queue 401 queues one or more jobs matching the user identification information, the process shifts to S2503. Processes in S2503 and subsequent steps are done for each job.

In S2503, the pull-print server 305 determines whether each job, which is determined in S2502 to match the user identification information, is suspended (whether the job undergoes a stop process in S2513, described later). The number of print planes is determined for each job which is determined in S2502 to match the user identification information. In other words, processes in S2503 and subsequent steps are performed for each job which is determined in S2502 to match the user identification information.

If YES in S2503, the process shifts to S2508. If NO in S2503, the pull-print server 305 receives a print plane count notification on the job from a device scheduler 600 in S2504. The number of print planes is the same as that described in S2203.

In S2505, similar to S2204, the pull-print server 305 compares the print plane count information notified from the device scheduler 600 with the total number of planes of the job (the number of pages in job information 1002 or job information). If the print plane count information coincides with the total number of planes of the job, the pull-print server 305 determines that printing of the job is already complete and performs, in S2514, the same process as that in S2206. Because the process of S2514 is same as that of S2206, a detailed description thereof will be omitted. If NO in S2505, the pull-print server 305 executes in S2506 and S2507 the same processes as those in S2205 and S2207. Note that job information referred to in S2505 is basically the same as that shown in FIG. 10, but further contains the device address (acquired from information shown in FIG. 13) of a printout destination printer in addition to the job information in FIG. 10.

In S2508, the pull-print server 305 determines whether the device address in FIG. 13 received in S2501 has changed from a device address contained in job information saved in advance in the form of FIG. 10. If YES in S2508, the process shifts to the flowchart in FIG. 25B (S2515 and subsequent steps) to execute a job control process when the printer is changed. If a match of the device address is confirmed in S2508, the pull-print server 305 determines that no printer has changed, and checks the device status in S2509.

The pull-print server 305 acquires the device status from the printer at an arbitrary timing on the basis of the “device address” shown in FIG. 13. It is also possible to cache the device status acquired at an arbitrary timing. In this case, the pull-print server 305 can refer to the device status at an asynchronous timing with the timing of acquiring device status from the printer.

If the pull-print server 305 determines in S2509 that the device status is abnormal, it cancels the process of the print job in S2512, and the process returns to S2501. This process can cope with a case where, for example, the print device runs out of sheets and a user wants to cancel the print job. That is, when the print device runs out of sheets, the user can cancel the job by causing the print device to recognize the authentication information recording medium 521.

If the pull-print server 305 determines in S2509 that the device status is normal, it determines in S2510 whether the job, which is determined in S2502 to match the user identification information, is being suspended. This determination can be made by referring to the “job status” field contained in job information of a job of interest as shown in FIG. 10. If YES in S2510 (the job status is “stop”), the pull-print server 305 outputs the job again to the printer in S2511. If NO in S2510, the pull-print server 305 suspends the job of interest (job determined in S2502 to match the user identification information) in S2513. The process in S2511 corresponds to S1410 and S1411 in FIG. 14, and the process in S2513 corresponds to the process in FIG. 22. The flowchart of FIG. 25A can also achieve job control such as cancellation or suspension of a print job, similarly to FIG. 22. This process allows a user to suspend a job by causing the print device to recognize the authentication information recording medium 521 at an arbitrary timing during standby for schedule up of the job or during printing of the job.

<Flowchart in FIG. 25B>

The flowchart in FIG. 25B will be described in detail. If a matching job is found in S2502 and the print agent of a printer different from a previous one notifies the pull-print server 305 of information in FIG. 13, the pull-print server 305 determines in S2508 that the printer has changed, and the process shifts to the flowchart of FIG. 25B. For example, when a user causes a print device different from a previous one which detected the authentication information recording medium 521 before, to detect the authentication information recording medium 521, the print agent of the different printer issues a notification.

In S2515, the pull-print server 305 determines whether the status of a printer corresponding to a device address (device address before change) contained in job information of interest is normal. The device status acquisition method has been described in S2509. If the pull-print server 305 determines in S2515 that the device status is abnormal, it executes substitute printing in S2516 and subsequent steps. If the pull-print server 305 determines in S2515 that the device status is normal, it executes distributed printing in S2519 and subsequent steps.

<Substitute Printing>

Substitute printing will be explained first. In S2516, the pull-print server 305 cancels a job of a printer before change. Job cancellation can be achieved by the same processes as those in S2202 and subsequent steps shown in FIG. 22. Processes in S2203 to S2207 are the same as those executed in S2504 to S2507 and S2514. That is, the processes in S2504 to S2507 and S2514 are repetitively executed by executing, in S2516, the processes in S2203 to S2207. Thus, the processes in S2203 to S2207 can also be omitted in S2516.

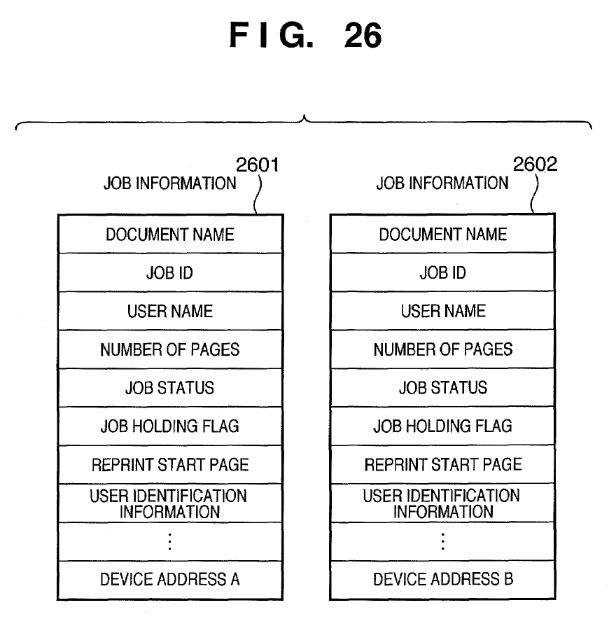

In S2517, the pull-print server 305 updates job information by setting the device address of another printer after change (the device address causing the pull-print server 305 to determine that the printer has changed in S2508) as the device address of the job information. This job information is identical to that shown in FIG. 10, and has a structure shown in FIG. 26 in the fourth embodiment. For example, when a printer before change corresponds to device address A and a printer after change corresponds to device address B, job information 2601 held in the pull-print server 305 changes to job information 2602.

In S2518, the pull-print server 305 performs a substitute output process to output a job to a substitute printer so as to print out subsequent unprinted pages on the basis of the updated job information. Thereafter, the process returns to S2501.

Note that, the first embodiment can also perform substitute printing by causing a print device different from one used so far, to detect an authentication information recording medium when printing is interrupted by the process in FIG. 22. That is, another print device detects the authentication information recording medium, and then processes in S1410 to S1414 of FIG. 14 are executed. An arbitrary printer can, therefore, execute substitute printing according to the user's intention. Even in the fourth embodiment, an arbitrary printer can execute substitute printing according to the user's intention, similar to the processes in S1410 to S1414 of FIG. 14.

<Distributed Printing>

If the pull-print server 305 determines in S2515 that the device status is normal, it executes distributed printing by assigning part of a job, which has been assigned to a printer before change, to a printer after change when it is determined in S2508 that the printer has changed. More specifically, in S2519, the pull-print server 305 creates a job which causes another printer to print part (e.g., half) of a job assigned to a printer before change. For example, the pull-print server 305 creates a job whose print start pages are latter pages (e.g., half of all pages+one page) of the job of the printer before change.

In S2520, the pull-print server 305 creates job information (FIG. 26) for the new job created in S2519, and registers a newly generated job ID in a corresponding job management queue (corresponding to one shown in FIG. 10). The pull-print server 305 updates the print range (end print page) of not the newly created job information but the divided job information.

In S2521, the pull-print server 305 implements distributed printing by outputting the job on the basis of the newly created job information to the printer having the pull-print agent over which the user puts the authentication information recording medium 521.

As described above, the fourth embodiment performs various print job control operations upon receiving a notification representing an identification information input status from the print device (print apparatus). For example, different job control is done in accordance with the notification representing the print apparatus status (S2509), the job status (S2510), or the print apparatus which outputs the notification (S2508). For example, one of suspension of job execution (S2513), substitute printing (S2516 to S2518), and distributed printing (S2519 to S2521) is executed in accordance with the notification.

The fourth embodiment can cancel or suspend a print job using the authentication information recording medium 521. In addition, the fourth embodiment can perform substitute printing or distributed printing by causing another print device to detect the authentication information recording medium 521.

### Fifth Embodiment

In the first to fourth embodiments, a print job held in the pull-print server 305 contains or is associated with user identification information. When the pull-print agent 606 notifies the pull-print server 305 of user identification information, the pull-print server 305 specifies and outputs a print job containing or associated with the notified user identification information.

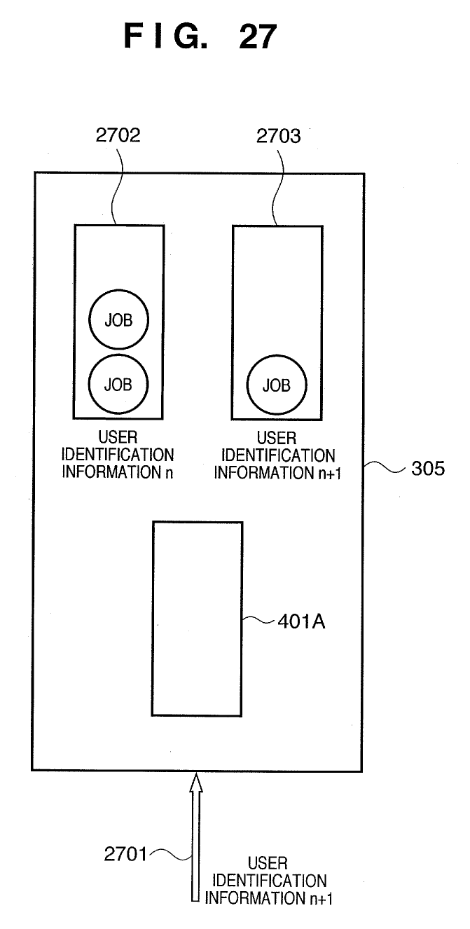

However, how to hold one or a plurality of print jobs in the pull-print server 305 according to the present invention is not limited to this. For example, a holding function as shown in FIG. 27 may hold one or a plurality of print jobs. How to hold one or a plurality of print jobs will be explained with reference to FIG. 27.

A pull-print server 305 in FIG. 27 corresponds to the pull-print server described with reference to FIG. 8. In FIG. 27, reference numeral 401A corresponds to the print queue 401A in FIG. 8.

In FIG. 27, reference numeral 2701 denotes an arrow in S805 of FIG. 8. Reference numeral 2702 denotes a virtual print queue which accumulates one or a plurality of print jobs instead of accumulating a print job in the pull-print queue 401 of FIG. 8 (not the print queue 401A of FIG. 8). Reference numeral 2703 denotes another virtual print queue.

A feature of the fifth embodiment is that user identification information is associated with the virtual print queues 2702 and 2703. In FIG. 27, “user identification information n” is associated with the virtual print queue 2702, whereas “user identification information n+1” is associated with the virtual print queue 2703. When a pull-print agent 606 notifies the pull-print server 305 of either user identification information, the pull-print server 305 searches for a virtual print queue corresponding to the notified user identification information. The condition that the pull-print agent 606 notifies the pull-print server 305 of user identification information is insertion and/or removal of an authentication information recording medium 521, as described above.

After the pull-print server 305 specifies the virtual print queue, the print queue 401A registers one or a plurality of print jobs registered in the specified virtual print queue. Immediately after the registration, the pull-print server 305 issues a scheduling request to a device scheduler 600. In FIG. 27, the pull-print server 305 is notified of the “user identification information n+1”, and searches for the virtual print queue 2703 on the basis of the notified “user identification information n+1”. Then, the print queue 401A registers one print job registered in the virtual print queue 2703.

As shown in FIG. 27, one or a plurality of print jobs to be printed can be easily specified by only searching for user identification information of the virtual print queue without using user identification information contained in or associated with a print job. Also in the fifth embodiment, similar to the first and second embodiments, a print job may contain or be associated with user identification information.

The pull-print server 305 which readably holds one or a plurality of print jobs on the basis of user identification information transmitted from a print apparatus can hold one or a plurality of print jobs in various forms.

### Other Embodiment

The object of the present invention is also achieved as follows. That is, a storage medium which records software program codes for implementing the functions of the above-described embodiments is supplied to a system or apparatus. The computer (or the CPU or MPU) of the system or apparatus reads out and executes the program codes stored in the storage medium.

In this case, the program codes read out from the storage medium implement new functions of the present invention, and the storage medium which stores the program codes constitutes the present invention.

The program can take any form such as an object code, a program executed by an interpreter, or script data supplied to an OS as long as the program has program functions.

The storage medium for supplying the program includes a flexible disk, hard disk, optical disk, magnetooptical disk, MO, CD-ROM, CD-R, CD-RW, magnetic tape, nonvolatile memory card, ROM, and DVD.

In this case, the program codes read out from the storage medium implement the functions of the above-described embodiments, and the storage medium which stores the program codes constitutes the present invention.

The program can also be supplied as follows. That is, a client computer connects to an Internet Web page via the browser of the client computer. The client computer downloads the computer program of the present invention or a compressed file containing an automatic installing function from the Web page to a recording medium such as a hard disk. The program can also be implemented by grouping program codes, which form the program of the present invention, into a plurality of files, and downloading the files from different Web pages. That is, claims of the present invention also incorporate a WWW server, FTP server, or the like which allows a plurality of users to download the program files for implementing functional processes of the present invention by a computer.

The program of the present invention can be encrypted, stored in a storage medium such as a CD-ROM, and distributed to a user. A user who satisfies predetermined conditions is prompted to download decryption key information from a Web page via the Internet. The user executes the encrypted program using the key information, and installs the program in the computer.

The functions of the above-described embodiments are implemented when the computer executes the readout program codes. Also, the functions of the above-described embodiments are implemented when an OS (Operating System) or the like running on the computer performs some or all of actual processes on the basis of the instructions of the program codes.

The functions of the above-described embodiments are also implemented as follows. That is, the program read out from the storage medium is written in the memory of a function expansion board inserted into the computer or the memory of a function expansion unit connected to the computer. Then, the CPU of the function expansion board or function expansion unit performs some or all of actual processes on the basis of the instructions of the program codes.

The present invention is not limited to the above embodiments, and various modifications (including organic combinations of the embodiments) can be made on the basis of the gist of the invention. These modifications are not excluded from the scope of the invention.

According to the present invention, a user can easily obtain a target printout material without compelling him to do cumbersome work, unlike a conventional pull-print system.

The present invention can also easily control a print job.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-380163, filed Dec. 28, 2005, and Japanese Patent Application No. 2006-305977, filed Nov. 10, 2006, which are hereby incorporated by reference herein in their entirety.

What is claimed is:

1. A server system communicable with a print apparatus, comprising:
a job generation unit adapted to generate a print job in accordance with a print instruction;
a holding unit adapted to hold at least one print job generated by said job generation unit in a readable form based on identification information common to a plurality of print jobs transmitted from the print apparatus;
a first reception unit adapted to receive a request accompanying identification information from the print apparatus; and
an output unit adapted to read at least one print job on the basis of the identification information contained in the request received by said first reception unit, and output the read print job to the print apparatus.

2. The system according to claim 1, further comprising:
a second reception unit adapted to receive, from the print apparatus, a notification representing an input status of the identification information in the print apparatus; and
a job control unit adapted to control a print job in response to reception of the notification by said second reception unit.

3. The system according to claim 2, wherein said job control unit performs different job control operations in accordance with a status of the print apparatus, a job status, or the print apparatus which outputs the notification.

4. The system according to claim 3, wherein the different job control operations include one of suspension of job execution, substitute printing, and distributed printing.

5. The system according to claim 2, wherein when the notification received by said second reception unit represents a state in which the print apparatus cannot input the identification information, said job control unit performs print job control in response to reception of the notification.

6. The system according to claim 5, wherein the print job control includes one of stop of a print job and cancellation of a print job.

7. The system according to claim 5, further comprising:
a third reception unit adapted to receive a notification of progress of a print job to be controlled by said job control unit; and
a hold control unit adapted to control said holding unit to hold, in correspondence with the print job to be controlled, job status information based on the progress notification received by said third reception unit.

8. The system according to claim 7, wherein when the job status information is held in correspondence with a print job read on the basis of the identification information contained in the request received by said first reception unit, said output unit outputs the print job again on the basis of the job status information.

9. The system according to claim 1, further comprising an informing unit adapted to inform the print apparatus that a print job is being output at a predetermined time interval, while said output unit outputs the print job.

10. The system according to claim 1, further comprising an output destination setting unit adapted to set, as an output destination of said at least one print job, output destination information contained in the request received by said first reception unit.

11. A print system in which an information processing apparatus and a print apparatus are communicable with each other, wherein
the information processing apparatus comprises:
a job generation unit adapted to generate a print job; and
a holding unit adapted to hold at least one print job in a readable form based on identification information common to a plurality of print jobs transmitted from the print apparatus,
the print apparatus comprises an issue unit adapted to issue a request accompanying identification information to the information processing apparatus, and
the information processing apparatus further comprises:
a first reception unit adapted to receive the request issued by said issue unit; and
an output unit adapted to read at least one print job on the basis of the identification information contained in the request received by said first reception unit, and output the read print job to the print apparatus.

12. A job control method by a server system communicable with a print apparatus, comprising:
a job generation step of generating a print job in accordance with a print instruction;
a holding step of holding, in a holding unit, at least one print job generated in the job generation step in a readable form based on identification information common to a plurality of print jobs transmitted from the print apparatus;
a first reception step of receiving a request accompanying identification information from the print apparatus; and
an output step of reading at least one print job on the basis of the identification information contained in the request received in the first reception step, and outputting the read print job to the print apparatus.

13. The method according to claim 12, further comprising:
a second reception step of receiving, from the print apparatus, a notification representing an input status of the identification information in the print apparatus; and
a job control step of controlling a print job in response to reception of the notification in the second reception step.

14. The method according to claim 13, wherein said job control step performs different job control operations in accordance with a status of the print apparatus, a job status, or the print apparatus which outputs the notification.

15. The method according to claim 14, wherein the different job control operations include one of suspension of job execution, substitute printing, and distributed printing.

16. The method according to claim 13, wherein when the notification received in second reception step represents a state in which the print apparatus cannot input the identification information, the job control step performs print job control in response to reception of the notification.

17. The method according to claim 16, wherein the print job control includes one of stop of a print job and cancellation of a print job.

18. The method according to claim 16, further comprising:
a third reception step of receiving a notification of progress of a print job to be controlled in the job control step; and
a hold control step of controlling the holding step to hold, in correspondence with the print job to be controlled, job status information based on the progress notification received in the third reception step.

19. The method according to claim 18, wherein when the job status information is held in correspondence with a print job read on the basis of the identification information contained in the request received in said first reception step, the output step outputs the print job again on the basis of the job status information.

20. The method according to claim 12, further comprising an informing step of informing the print apparatus that a print job is being output at a predetermined time interval, while the output step outputs the print job.

21. The method according to claim 12, further comprising an output destination setting step of setting, as an output destination of said at least one print job, output destination information contained in the request received in the first reception step.

22. A job control method by a print system in which an information processing apparatus and a print apparatus are communicable with each other, comprising:
a job generation step of causing the information processing apparatus to generate a print job;
a holding step of causing the information processing apparatus to hold, in a holding unit, at least one print job in a readable form based on identification information common to a plurality of print jobs transmitted from the print apparatus;
an issue step of causing the print apparatus to issue a request accompanying identification information to the information processing apparatus;
a first reception step of causing the information processing apparatus to receive the request issued in the issue step; and
an output step of reading at least one print job on the basis of the identification information contained in the request received in the first reception step, and outputting the read print job from the information processing apparatus to the print apparatus.

23. A computer program which is stored in a storage medium and causes a computer to execute a job control method by a server system communicable with a print apparatus, the job control method comprising:
a job generation step of generating a print job in accordance with a print instruction;
a holding step of holding, in a holding unit, at least one print job generated in the job generation step in a readable form based on identification information common to a plurality of print jobs transmitted from the print apparatus;
a first reception step of receiving a request accompanying identification information from the print apparatus; and
an output step of reading at least one print job on the basis of the identification information contained in the request received in the first reception step, and outputting the read print job to the print apparatus.

24. A computer-readable storage medium which stores a computer program for causing a computer to execute a job control method by a server system communicable with a print apparatus, the job control method comprising:
a job generation step of generating a print job in accordance with a print instruction;
a holding step of holding, in a holding unit, at least one print job generated in the job generation step in a readable form based on identification information common to a plurality of print jobs transmitted from the print apparatus;
a first reception step of receiving a request accompanying identification information from the print apparatus; and
an output step of reading at least one print job on the basis of the identification information contained in the request received in the first reception step, and outputting the read print job to the print apparatus.
